(19) United States
(12) Patent Application Publication
(10) Pub. No.: US 2026/0228328 A1
(43) Pub. Date: Aug. 6, 2026

(54) DEVICE, METHOD AND SYSTEM TO PROTECT COMMUNICATIONS WITH A RESOURCE OF A TRUSTED EXECUTION ENVIRONMENT

(71) Applicant: Intel Corporation, Santa Clara, CA (US)

(72) Inventors: Shalini Sharma, Folsom, CA (US); Christopher Van Beek, Cornelius, OR (US); Filip Schmole, Portland, OR (US); Arie Aharon, Portland, OR (US); Raghunandan Makaram, Northborough, MA (US); Tessil Thomas, Cambridge (GB)

(73) Assignee: Intel Corporation, Santa Clara, CA (US)

(21) Appl. No.: 19/093,010

(22) Filed: Mar. 27, 2025

Related U.S. Application Data
(60) Provisional application No. 63/754,471, filed on Feb. 5, 2025.

(51) Int. Cl. G06F 21/53

(52) U.S. Cl. CPC G06F 21/53; G06F 2221/033

(57) ABSTRACT

Techniques and mechanisms for facilitating secure communications in a trusted execution environment (TEE). In an embodiment, one of a root complex or an input-output device provides functionality to register a message tag as being at least temporarily unavailable for use in any communication via a protected channel. In an embodiment, tag registry is based on a timeout of a completion message which was expected to include, or otherwise correspond to, the tag in question. A registered tag is unavailable for use at least until the completion timeout has been determined to have a cause other than a malicious agent. In another embodiment, a TEE security manager (TSM) or a device security manager (DSM) provides functionality to generate an explicit request that an integrity and data encryption (IDE) protected channel be flushed.

### CLAIM OF PRIORITY

This application claims priority to U.S. Provisional Patent Application No. 63/754,471, filed on Feb. 5, 2025 and titled “DEVICE, METHOD AND SYSTEM TO MITIGATE THREATS TO COMMUNICATIONS WITH A RESOURCE OF A TRUSTED EXECUTION ENVIRONMENT,” which is hereby incorporated by reference in entirety.

### BACKGROUND

### 1. Technical Field

This disclosure generally relates to communication channel security and more particularly, but not exclusively, to protecting data input/output with resource of a trusted execution environment.

### 2. Background Art

A processor, or set of processors, executes instructions from an instruction set, e.g., the instruction set architecture (ISA). The instruction set is the part of the computer architecture related to programming, and generally includes the native data types, instructions, register architecture, addressing modes, memory architecture, interrupt and exception handling, and external input and output (IO). It should be noted that the term instruction herein may refer to a macro-instruction, e.g., an instruction that is provided to the processor for execution, or to a micro-instruction, e.g., an instruction that results from a processor's decoder decoding macro-instructions.

Some processors support a Trusted Execution Environment (TEE) to ensure that code and data loaded in a secured TEE compute or storage device is protected for confidentiality and integrity. Generally, “confidentiality” can be provided by memory encryption to protect code and/or data. Moreover, “data integrity” aims to prevent unauthorized entities from altering TEE data when an entity outside the TEE processes data and “code integrity” ensures that any code associated with the TEE is not replaced or modified by unauthorized entities.

Compute Express Link (CXL) is one type of open standard interconnect for high-speed central processing unit (CPU) to device and CPU-to-memory communications, designed to accelerate next-generation data center performance. CXL is built upon the Peripheral Component Interconnect express (PCIe) physical and electrical interface specification (conforming to version 3.0 or other versions of the PCIe standard published by the PCI Special Interest Group (PCI-SIG)) with protocols in three areas: input/output (I/O), memory and cache coherence.

### BRIEF DESCRIPTION OF THE DRAWINGS

The various embodiments of the present invention are illustrated by way of example, and not by way of limitation, in the figures of the accompanying drawings and in which:

FIG. 1 shows a block diagram illustrating features of a computer system to protect communications in a trusted execution environment according to an embodiment.

FIG. 2 shows a block diagram illustrating features of a system to manage the use of tags in communications via a protected channel according to an embodiment.

FIG. 3 shows a flow diagram illustrating features of a method to limit the use of a tag in a protected communication according to an embodiment.

FIG. 4 shows a block diagram illustrating features of an integrated circuit to selectively prevent the use of a tag associated with a completion timeout according to an embodiment.

FIG. 5 shows a flow diagram illustrating features of a method to manage communication tags according to an embodiment.

FIG. 6 shows a block diagram illustrating features of a system to protect communications in a trusted execution environment according to an embodiment

FIGS. 7A, 7B show block diagrams each illustrating features of a respective system to provide protections for communications in a trusted execution environment according to a corresponding embodiment.

FIG. 8 shows a flow diagram illustrating features of a method to determine a state of a communication channel according to an embodiment.

FIG. 9 shows a block diagram illustrating features of a system to facilitate protection of a communication channel according to an embodiment.

FIG. 10 shows a block diagram illustrating features of a system to determine a state of a channel in a trusted execution environment according to an embodiment.

FIG. 11 shows a block diagram illustrating features of a system to flush a protected communication channel according to an embodiment.

FIG. 12 illustrates an exemplary system.

FIG. 13 illustrates a block diagram of an example processor that may have more than one core and an integrated memory controller.

FIG. 14A is a block diagram illustrating both an exemplary in-order pipeline and an exemplary register renaming, out-of-order issue/execution pipeline according to examples.

FIG. 14B is a block diagram illustrating both an exemplary example of an in-order architecture core and an exemplary register renaming, out-of-order issue/execution architecture core to be included in a processor according to examples.

FIG. 15 illustrates examples of execution unit(s) circuitry.

FIG. 16 is a block diagram of a register architecture according to some examples.

### DETAILED DESCRIPTION

Embodiments discussed herein variously provide techniques and mechanisms for promoting secure communications with a resource of a trusted execution environment. The description herein includes numerous details to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

In various embodiments, a processor—e.g., a hardware processor—comprises one or more cores for executing instructions (in a thread of instructions) to operate on data, for example, to perform arithmetic, logic, or other functions. For example, software requests an operation and a hardware processor (e.g., a core or cores thereof) performs the operation in response to the request. Certain operations include accessing one or more memory locations, e.g., to store and/or read (e.g., load) data. In some embodiments, a system includes one or more cores, e.g., with a proper subset of cores in each socket of a plurality of sockets, e.g., of a system-on-a-chip (SoC). A given one or more cores—e.g., each processor or each socket—accesses data storage (e.g., a memory). For example, a memory includes volatile memory (e.g., dynamic random-access memory (DRAM)) or (e.g., byte-addressable) persistent (e.g., non-volatile) memory (e.g., non-volatile RAM) (e.g., separate from any system storage, such as, but not limited, separate from a hard disk drive). One example of persistent memory is a dual in-line memory module (DIMM) (e.g., a non-volatile DIMM) (e.g., an Intel® Optane™ memory), for example, accessible according to a Peripheral Component Interconnect Express (PCIe) standard.

In certain embodiments, a virtual machine (VM) (e.g., guest) is an emulation of a computer system. In certain embodiments, VMs are based on a specific computer architecture and provide the functionality of an underlying physical computer system. Their implementations involve specialized hardware, firmware, software, or a combination. In certain embodiments, a virtual machine monitor (VMM) (also known as a hypervisor) is a software program that, when executed, enables the creation, management, and governance of VM instances and manages the operation of a virtualized environment on top of a physical host machine. A VMM is the primary software behind virtualization environments and implementations in certain embodiments. When installed over a host machine (e.g., processor) in certain embodiments, a VMM facilitates the creation of VMs, e.g., each with separate operating systems (OS) and applications. The VMM manages the backend operation of these VMs by allocating the necessary computing, memory, storage, and other input/output (I/O) resources, such as, but not limited to, an input/output memory management unit (IOMMU) (e.g., an IOMMU circuit). The VMM provides a centralized interface for managing the entire operation, status, and availability of VMs that are installed over a single host machine or spread across different and interconnected hosts.

However, it is desirable to maintain the security (e.g., confidentiality) of information for a virtual machine from the VMM and/or other virtual machine(s). Certain processors (e.g., a system-on-a-chip (SoC) including a processor) utilize their hardware and/or firmware to isolate virtual machines, for example, with each referred to as a “trust domain” (e.g., a “trust zone”, “secure environment”, “trusted area”, or “secure area”). Certain processors support an instruction set architecture (ISA) (e.g., ISA extension) to implement trust domains. For example, Intel® trust domain extensions (Intel® TDX) that utilize architectural elements to deploy (e.g., hardware-isolated) virtual machines (VMs) referred to as trust domains (TDs). In certain embodiments, a processor, that implements a trust domain manager, is to utilize the processor's hardware to isolate each trust domain, e.g., isolated from the hosting VMM and service OS environments. In certain embodiments, a trust domain manager is built using a combination of instruction-set-architecture (ISA) extensions, multi-key total-memory-encryption (MKTME) technology (e.g., circuitry), and a CPU-attested software module.

In certain embodiments, a hardware processor and its ISA (e.g., a trust domain manager thereof) isolates TD VMs from the VMM (e.g., hypervisor) and/or other non-TD software (e.g., on the host platform). In certain embodiments, a hardware processor and its ISA (e.g., a trust domain manager thereof) implement trust domains to enhance confidential computing by helping protect the trust domains from a broad range of software attacks and reducing the trust domain's trusted computing base (TCB). In certain embodiments, a hardware processor and its ISA (e.g., a trust domain manager thereof) enhance a cloud tenant's control of data security and protection. In certain embodiments, a hardware processor and its ISA (e.g., a trust domain manager thereof) implement trust domains (e.g., trusted virtual machines) to enhance a cloud-service provider's (CSP) ability to provide managed cloud services without exposing tenant data to adversaries.

In certain embodiments, a hardware processor and its ISA (e.g., a trust domain manager thereof) also support device input/output (IO). For example, with an ISA (e.g., Intel® TDX 2.0) supporting trust domain extension (TDX) with device input/output (IO) (e.g., TDX-IO). In certain embodiments, a hardware processor and its ISA (e.g., a trust domain manager thereof) that support device input/output (IO) (e.g., TDX-IO) enables the use (e.g., assignment) of a physical function (PF) and/or a virtual function (VF) of a device to (e.g., only) a specific TD.

While various embodiments described herein use the term System-on-a-Chip or System-on-Chip (“SoC”) to describe a device or system having a processor and associated circuitry (e.g., IO circuitry, power delivery circuitry, memory circuitry, etc.) integrated monolithically into a single integrated circuit (“IC”) die, or chip, the present disclosure is not limited in that respect. For example, in various embodiments, a device or system can have one or more processors (e.g., one or more processor cores) and associated circuitry (e.g., IO circuitry, power delivery circuitry, etc.) arranged in a disaggregated collection of discrete dies, tiles and/or chiplets (e.g., one or more discrete processor core die arranged adjacent to one or more other die such as memory die, IO die, etc.). In such disaggregated devices and systems, the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).

Certain trust domains (TDs) are used to host confidential computing workloads isolated from hosting environments. Certain trust domain technology (e.g., TDX 1.0) architecture enables isolation of the TD (e.g., central processing unit (CPU)) context and memory from the hosting environment, but does not support trusted IO (e.g., direct memory access (DMA) or memory-mapped IO (MMIO)) to TD private memory, e.g., leading to higher overheads as trust domains are to use a software mechanism for protecting data sent to IO devices (e.g., storage, network, etc.), for example, where all IO data is sent through bounce buffers in TD shared memory using para-virtualized interfaces. However, in certain embodiments, this precludes the use of some IO models, such as, but not limited to, scalable IO virtualization (IOV), shared virtual memory, direct IO assignments, and compute offload to an accelerator, field-programmable gate array (FPGA), and/or graphics processing unit (GPU). Thus, from an IO perspective, certain trust domain technology (e.g., TDX 1.0) suffers from the limitations of 1) functionality (e.g., security) because protection can only be extended for devices having the capabilities of end to end encryption (e.g., hardware (H/W) or software (S/W) stack based), as well as no support for state of the art IO virtualization/programming models, and 2) performance because copying for bounce buffers (and software based encryption) incurs significant performance overheads, especially with increased speed/bandwidth of IO devices (e.g., accelerators).

Certain trust domain technology (for example, trust domain extensions (TDX) with device input/output (IO) (e.g., TDX-IO)) defines the hardware, firmware, and/or software extensions to enable direct and trusted IO between TDs and corresponding IO (e.g., TDX-IO) enlightened devices, and thus overcomes the above limitations.

Certain systems (e.g., SoCs) are to implement and/or otherwise utilize trust domain (e.g., trusted execution environment (TEE)) extensions (e.g., TDX) to enable direct and trusted IO between a trust domain (TD) and a corresponding IO device (e.g., IO device integrated into a SoC). Certain systems (e.g., devices) utilize a device security manager (DSM) to implement direct and trusted IO between a trust domain (TD) and a corresponding IO device.

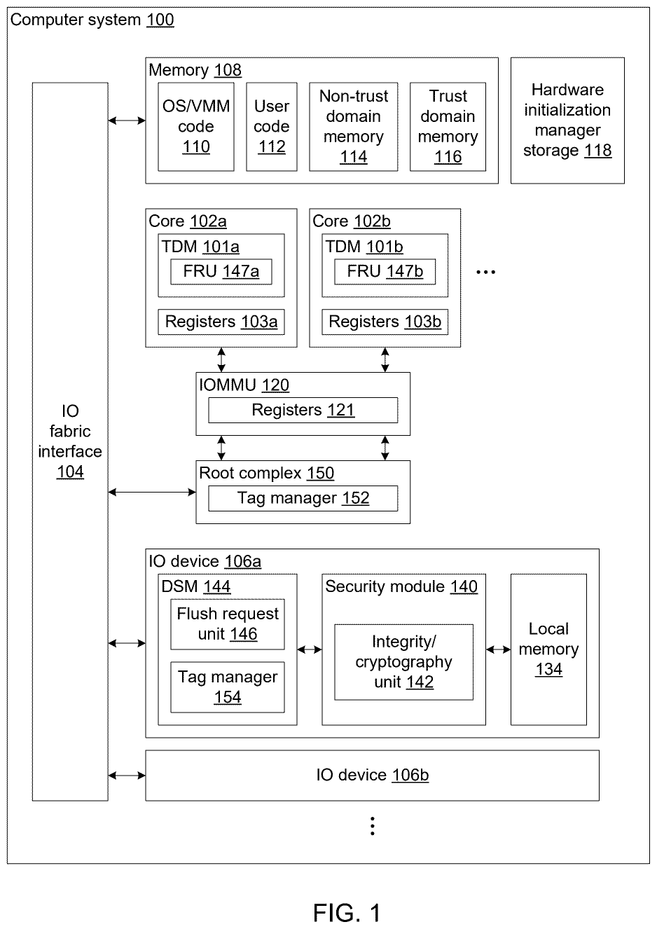

Turning now to FIG. 1, an example system architecture is depicted. FIG. 1 illustrates a block diagram of a computer system 100 including one or more cores 102, some or all of which each provide a respective trust domain manager (TDM). For example, the illustrative cores 102a, 102b, etc. provide respective TDMs 101a, 101b, etc. In an embodiment, computer system 100 further comprises a memory 108 (e.g., a system memory coupled to a processor and/or core memory), an input/output memory management unit (IOMMU) 120 (e.g., circuit), and an input/output (IO) device 106.

In certain embodiments, each core includes (e.g., or logical includes) a set of registers, e.g., registers 103a for core 102a, registers 103b for core 102b, etc. Registers 103 include, for example, data registers and/or control registers, e.g., for each core (e.g., or each logical core of a plurality of logical cores of a physical core).

In certain embodiments, a processor (e.g., processor core 102) is to implement a trust domain manager 101. In certain embodiments, trust domain manager (TDM) code is a processor (e.g., CPU) attested software module that implements the functions to build, tear down, and start execution of trust domains. In certain embodiments, a processor (e.g., processor core 102) is to implement a trust domain manager to manage one or more virtual machines as a respective trust domain isolated from a virtual machine monitor (e.g., hosting VMM) and/or service OS environments.

During operation of computer system 100, memory 108 includes operating system (OS) and/or virtual machine monitor code 110, user (e.g., program) code 112, non-trust domain memory 114 (e.g., pages), trust domain memory 116 (e.g., pages), uncompressed data (e.g., pages), compressed data (e.g., pages), or any combination thereof. In certain embodiments of computing, a virtual machine (VM) is an emulation of a computer system. In certain embodiments, VMs are based on a specific computer architecture and provide the functionality of an underlying physical computer system. Their implementations involve specialized hardware, firmware, software, or a combination. In certain embodiments, the virtual machine monitor (VMM) (also known as a hypervisor) is a software program that, when executed, enables the creation, management, and governance of VM instances and manages the operation of a virtualized environment on top of a physical host machine. A VMM is the primary software behind virtualization environments and implementations in certain embodiments. When installed over a host machine (e.g., processor) in certain embodiments, a VMM facilitates the creation of VMs, e.g., each with separate operating systems (OS) and applications. The VMM manages the backend operation of these VMs by allocating the necessary computing, memory, storage, and other input/output (IO) resources, such as, but not limited to, an input/output memory management unit (IOMMU). The VMM provides a centralized interface for managing the entire operation, status, and availability of VMs that are installed over a single host machine or spread across different and interconnected hosts.

In some embodiments, memory 108 includes memory which is distinct from a core and/or device 106. Memory 108 includes DRAM, in an embodiment. Compressed data is stored in a first memory device (e.g., a relatively far memory) and/or uncompressed data is stored in a separate, second memory device (e.g., a relatively near memory).

A coupling (e.g., input/output (IO) fabric interface 104) is included to allow communication between device 106, core(s) 102a, 102b, memory 108, etc.

In certain embodiments, a hardware initialization manager (non-transitory) storage 118 stores hardware initialization manager firmware (e.g., or software). In one embodiment, the hardware initialization manager (non-transitory) storage 118 stores Basic Input/Output System (BIOS) firmware. In another embodiment, the hardware initialization manager (non-transitory) storage 118 stores Unified Extensible Firmware Interface (UEFI) firmware. In certain embodiments (e.g., triggered by the power-on or reboot of a processor), computer system 100 (e.g., at core 102a) executes the hardware initialization manager firmware (e.g., or software) stored in hardware initialization manager (non-transitory) storage 118 to initialize the system 100 for operation, for example, to begin executing an operating system (OS) and/or initialize and test the (e.g., hardware) components of system 100.

In certain embodiments, computer system 100 includes an input/output memory management unit (IOMMU) 120 (e.g., circuitry), e.g., coupled between one or more cores 102a, 102b and IO fabric interface 104. For example, IOMMU 120 is coupled to fabric interface 104 via a root complex 150. In certain embodiments, IOMMU 120 provides address translation, for example, from a virtual address to a physical address. In certain embodiments, device 106 has a mode for support of shared virtual memory, whereby virtual addresses are specified in a descriptor, and the hardware translates these into physical addresses using address translation services of the IOMMU 120. In certain embodiments, IOMMU 120 includes one or more registers 121, for example, data registers and/or control registers.

A device 106 includes any of the depicted components. In certain embodiments, device 106 includes (or is coupled to) a local memory 134. In certain embodiments, device 106 is a TEE IO capable device, for example, with the host (e.g., processor including one of more of cores 102a, 102b) being a TEE capable host. In certain embodiments, a TEE capable host implements a TEE security manager (TSM).

In certain embodiments, a trusted execution environment (TEE) security manager (e.g., implemented by a trust domain manager 101) is to: provide interfaces to the VMM to assign memory, processor, and other resources to trust domains (e.g., trusted virtual machines), (ii) implements the security mechanisms and access controls (e.g., IOMMU translation tables, etc.) to protect confidentiality and integrity of the trust domains (e.g., trusted virtual machines) data and execution state in the host from entities not in the trusted computing base of the trust domains (e.g., trusted virtual machines), (iii) uses a protocol to manage the security state of the trusted device interface (TDI) to be used by the trust domains (e.g., trusted virtual machines), (iv) establishing/managing IDE encryption keys for the host, and, if needed, scheduling key refreshes. TSM programs the IDE encryption keys into the host root ports and communicates with the DSM to configure integrity and data encryption (IDE) encryption keys in the device, (v) or any single or combination thereof.

In certain embodiments, a device security manager (DSM) 144 is to (i) support authentication of device identities and measurement reporting, (ii) configure the IDE encryption keys in the device (e.g., where the TSM provide the keys for the initial configuration and subsequent key refreshes to the DSM), (iii) provide device interface management for locking TDI configuration, reporting TDI configurations, attaching, and detaching TDIs to trust domains (e.g., trusted virtual machines), (iv) implements access control and security mechanisms to isolate trust domain (e.g., trusted virtual machine) provided data from entities not in the TCB of a trust domain (e.g., a trusted virtual machine), (v) or any single or combination thereof. In certain embodiments, device security manager (DSM) 144 includes a set of one or more registers (not shown) comprising, for example, control registers and/or status registers.

In certain embodiments, a standard defines a virtual machine monitor (VMM) (e.g., or VM thereof), TSM (e.g., trust domain manager 101), and device security manager (DSM) 144 interaction flow.

In certain embodiments, IOMMU 120 and trust domain manager(s) 101 cooperate to allow for direct memory access (e.g., directly) between (e.g., to and/or from) IO device(s) 106 and trust domain memory 116 (e.g., a region for only a single trust domain and/or another region shared by a plurality of trust domains).

In order to establish the trust relationship between a device and a TD, certain TDX-IO architectures require the TD and/or a trust domain manager (e.g., circuit and/or code) (e.g., Trusted Execution Environment (TEE) security manager (TSM)) to create a secure communication session between the device and the trust domain manger (e.g., for the trust domain manger to allow a particular trust domain to use the device or a subset of function(s) of the device). In order to establish the trust relationship between a device and a TD, certain TDX-IO architectures require the TD and/or a trust domain manager (e.g., circuit and/or code) (e.g., Trusted Execution Environment (TEE) security manager (TSM)) use (i) a Distributed Management Task Force (DMTF) Secure Protocol and Data Model (SPDM) standard to authenticate the device (e.g., and collect device measurement), and (ii) use a Peripheral Component Interconnect Special Interest Group (PCI-SIG) TEE Device Interface Security Protocol (TDISP) standard (e.g., to communicate with a device security manager (DSM) to manage the device's virtual function(s)).

In certain embodiments, a SPDM messaging protocol defines a request-response messaging model between two endpoints to perform the message exchanges outlined in SPDM message exchanges, for example, where each SPDM request message shall be responded to with an SPDM response message as defined in the SPDM specification.

In certain embodiments, a TDISP messaging protocol defines a request-response messaging model between two endpoints to perform the message exchanges outlined in TDISP message exchanges, for embodiment, where each TDISP request message shall be responded to with an TDISP response message as defined in the TDISP specification. In certain embodiments, an endpoint's (e.g., device's) “measurement” describes the process of calculating the cryptographic hash value of a piece of firmware/software or configuration data and tying the cryptographic hash value with the endpoint identity through the use of digital signatures. This allows an authentication initiator to establish that the identity and measurement of the firmware/software or configuration running on the endpoint.

In certain embodiments, a security module 140 of an IO device 106 facilitates IO security mechanisms as described herein. For example, an integrity/cryptography unit 142 of security module 140 provides integrity protection and cryptographic protection for one or more communication channels by which IO device 106 communicates (for example) with a TDM 101, with another IO device of computer system 100, and/or the like.

As described herein, root complex 150 comprises a tag manager 152 which provides functionality to classify a given one or more identifier values (“tags” herein) each as being currently unavailable for communication in a given message via a protected channel. In various embodiments, such tag manager functionality is additionally or alternatively provided at an IO device—e.g., as represented by the illustrative tag manager 154. Unless otherwise indicated, “protected channel” refers herein to a communication channel for which one or more integrity protections and one or more cryptographic protections are provided. For example, a protected channel is supported by IDE features which are compatible with any of various suitable IDE standards—e.g., including, but not limited to, that set forth in the Peripheral Component Interconnect Express (PCIe) 6.0 specification, published January 2022 and/or various other such specifications published by the Peripheral Component Interconnect Special Interest Group (PCI-SIG).

In an illustrative embodiment, tag manager 152 includes, is coupled to access, or otherwise operates based on a list of any tags which have each been identified as corresponding to a previous completion timeout (e.g., wherein said completion timeout has yet to be identified as being “benign”, or not associated with any attack by a malicious agent). In various embodiments, tag manager 152 further includes, is coupled to access, or otherwise operates based on circuitry which can classify a given protected channel as currently being in any of multiple possible states (e.g., including an insecure state, a secure state, or the like).

Various embodiments additionally or alternatively facilitate a draining of a protected channel—e.g., to assure that any message (of at least one or more message types) which are currently in-flight are drained each to an interface at a respective terminus of the protected channel. By way of illustration and not limitation, TDM 101a includes or is otherwise operable to provide functionality—represented by the illustrative flush request unit (FRU) 147a—by which core 102a is to request the flushing of a given IDE protected channel. FRU 147a is provided with logic of core 102a—e.g., the logic including any of various suitable combinations of circuit hardware, firmware and/or executing software—to generate an explicit channel flush request. Alternatively or in addition, TDM 101b similarly provides functionality of a FRU 147b by which core 102b is to request a respective channel flush.

In various embodiments, some or all of IO device(s) 106 additionally or alternatively support channel flush requests—e.g., wherein a FRU 146 of DSM 144 provides functionality similar to that of FRU 147a. In one such embodiment, FRU 146 is operable to reply to a channel flush request from flush request unit 147a and/or is operable, for example, to send a channel flush request to a corresponding flush request unit (not shown) of IO device 106b.

In some embodiments, computer system 100 supports tag management functionality (such as that of tag manager 152) at root complex 150 and/or at IO device(s) 106, but omits flush request functionality at any of processor cores 102 and at any of IO device(s) 106. In other embodiments, computer system 100 supports flush request functionality at some or all of processor cores 102 and/or at some or all of IO devices 106, but omits tag management functionality at root complex 150 and at IO device(s) 106.

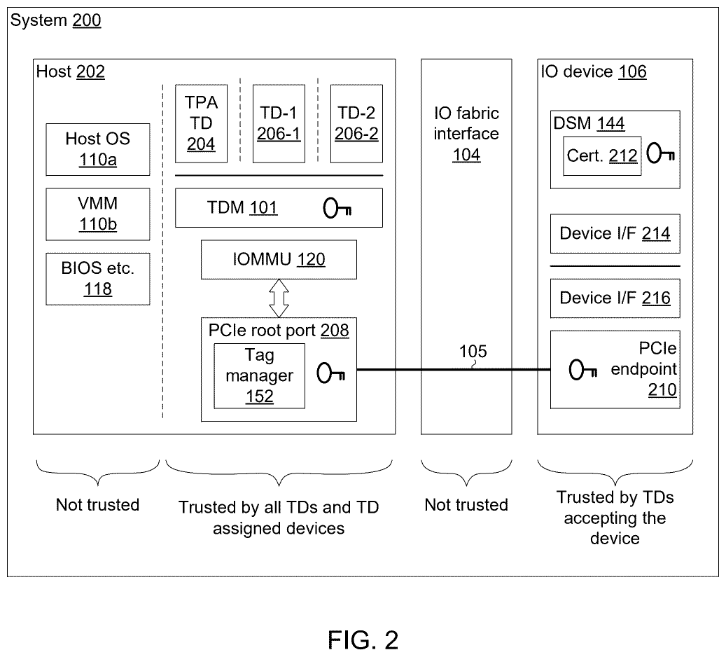

FIG. 2 illustrates a functional diagram of a system 200 comprising a host 202 (e.g., one or more of processor cores 102 in FIG. 1) coupled to an (e.g., discrete, and not integrated) IO device 106 (e.g., TDX-IO capable device) according to some embodiments. In certain embodiments, host 202 implements a TDX-IO provisioning agent (TPA) 204 of trust domains, and a plurality of trust domains, shown as trust domain “1” 206-1 and trust domain “2” 206-2, although any single or plurality of trust domains are implemented. In certain embodiments, host 202 includes a trust domain manager 101 to manage the trust domains (for example, with the vertical dashed lines indicating isolation therebetween the trust domains, e.g., and host OS 110a implemented by host 202 during operation, VMM 110b implemented by host 202 during operation, and BIOS, etc. 118). In certain embodiments, the virtual machine monitor 110b manages (e.g., generates) one or more virtual machines, e.g., with the trust domain manager 101 isolating a first virtual machine as a first trust domain from a second (or more) virtual machine and second (or more) trust domain(s). In certain embodiments, the host 202 includes a (e.g., PCIe) root port 208 having a key(s) (shown symbolically) to allow secure communications with the IO device 106, e.g., with the (e.g., PCIe) endpoint 210 thereof (e.g., also having the key(s) (shown symbolically)). In certain embodiments, the trust domain manager 101 and device security manager 144 are also to have a key(s), e.g., representing a memory protection key(s) and a secure session key(s), respectively.

In certain embodiments, the host 202 is coupled to device 106 via an IO fabric interface 104, e.g., via a secured link 105 (e.g., a link according to a PCIe/Compute Express Link (CXL) standard).

In certain embodiments, the host 202 is coupled to device 106 according to a transport level (e.g., SPDM) specification and/or an application level (e.g., TDISP) specification. In certain embodiments, device 106 includes a device security manager (DSM) 144 with a device secret(s), e.g., device certificate 212, session key, device “measurement” values, etc. In certain embodiments, device 106 implements one or more physical function(s) and/or virtual function(s) and/or assignable device interfaces (e.g., scalable IOV assignable device interfaces (ADIs)).

In certain embodiments, device 106 includes a first device interface (I/F) 214 on the device side, and one or more second device interface(s) 216, e.g., where the device 106 supports intra context isolation between these interfaces.

In certain embodiments, device 106 (e.g., according to a single-root input/output virtualization (SR-IOV) standard) is shared by a plurality of virtual machines (e.g., trust domains). In certain embodiments, a physical function has the ability to move data in and out of the device while virtual functions (for example, first virtual function and second virtual function, e.g., where the virtual functions are lightweight (e.g., PCI express (PCIe)) functions that support data flowing but also have a restricted set of configuration resources.

In certain embodiments, IO device 106 is to perform a direct memory access request to a private memory of a trust domain (e.g., trust domain 206-1 or trust domain 206-2) under the control of the IOMMU 120.

Certain processors (e.g., SoC) support trusted execution environments (TEE) (e.g., trust domain extensions (TDX)) that use architectural elements to help deploy hardware-isolated, virtual machines (VMs) called trust domains (TDs). In certain embodiments, TEE (e.g., TDX) is designed to isolate VMs from the virtual-machine manager (VMM)/hypervisor and any other non-TD software on the platform to protect TDs from a broad range of software. Certain TEE (e.g., TDX) support TEE-IO framework (e.g., shown in FIG. 2) that enables direct assignment of trusted device interfaces of (e.g., PCIe) discrete devices to TDs.

In certain embodiments, trust domain manager 101 (e.g., TEE security manager (TSM)) is a logical entity in a host that is the trusted computing base (TCB) for a trusted domain (e.g., trusted virtual machine) and enforces security policies on the host. In certain embodiments, the device security manager (DSM) 144 is a logical entity in the device that is admitted into the TCB for a TD by the TSM and enforces security policies on the device.

In certain embodiments, the trust domain manager 101 (e.g., TEE security manager (TSM) (e.g. TDX-module): (i) provides interfaces to the VMM to assign memory, processor, and other resources to trust domains (e.g., trusted virtual machines), (ii) implements the security mechanisms and access controls (e.g., IOMMU translation tables, EPT tables, etc.) to protect confidentiality and integrity of the trust domains data and execution state in the host from entities not in the trusted computing base of the trust domains, (iii) uses a protocol to manage the security state of the trusted device interface (TDI) to be used by the trust domains, and (iv) establishes/manages IDE encryption keys for the host, and, if needed, scheduling key refreshes. In certain embodiment, the trust domain manager (e.g., TSM) programs the IDE encryption keys into the host root ports and communicates with the DSM to configure integrity and data encryption (IDE) encryption keys in the device.

In certain embodiments, device security manager (DSM) 144 (i) supports authentication of device identities and measurement reporting, (ii) configuration of the IDE encryption keys in the device (e.g., where the trust domain manager (e.g., TSM) provide the keys for the initial configuration and subsequent key refreshes to the DSM), (iii) provides device interface management for locking TDI configuration, reporting TDI configurations, attaching, and detaching TDIs to trust domains, and (iv) implements access control and security mechanisms to isolate trust domain (e.g., trusted virtual machine) provided data from entities not in the TCB of a trust domain.

In order to establish the trust relationship between the device and TD, in certain embodiments, a TEE-JO architecture requires that the TD and/or trust domain manager (e.g., TSM) uses the DMTF Secure Protocol and Data Model (SPDM) to authenticate the device & collect the device measurements and/or use PCI-SIG TEE Device Interface Security Protocol (TDISP) to manage the trusted device interfaces.

In certain embodiments, the trust domain manager 101 is trusted by each trust domain, e.g., but a trust domain does not trust another trust domain. In certain embodiments, each trust domain of a plurality of trust domains includes its own respective trust domain state and/or memory.

In traditional non-TEE cases, completion timeouts are typically the result of misrouting due, for example, to device/fabric misconfiguration, to reliability, availability and serviceability (RAS) issues, or to async removal or device bugs. Completion timeouts have the potential to create data integrity and confidentiality issues. For example, if a completion message is received after it has already timed out, it is subject to being matched with a new read request, leading to corruption of the new read request. This is often referred to as an orphaned completion. In this context, an orphaned completion is a completion whose original read request has been retired due to a completion timeout. If the requestor identifier and tag of the orphaned completion matches with a new non-posted request, the completion can be incorrectly matched with the new non-posted request, causing data corruption.

In many non-TEE environments, a completion timeout is reported to a VMM, and PCIe architectures (for example) define various mechanisms for reporting and handling a completion timeout. By contrast, some TEE technologies are variously subject to excluding a VMM, a PCIe fabric, system timers and/or other resources from trust protections, which can increase other security risks. For example, an untrusted PCIe fabric is susceptible to maliciously delays in the communication of a completion message, which contributes to the risk of completion timeouts and associated data corruption.

Some embodiments variously comprise techniques and/or mechanism to handle various types of threats to mitigate risks to a TEE from data corruption based on a completion timeout. Some embodiments address the challenge of maintaining data integrity and confidentiality in trusted execution environments (TEEs) when a completion timeout occurs.

By way of illustration and not limitation, when a completion timeout occurs, some embodiments ensure that it does not compromise the confidentiality and integrity of the data within the TEE that generated the request or any other TEEs with trusted devices. The preservation of data integrity and confidentiality offsets possible availability issues, such as delays or reduced performance.

In an illustrative scenario according to one embodiment, a hardware-based approach is implemented in a PCIe root port (RP) or a device endpoint (EP) such as any of various suitable IO devices. Some embodiments extend hardware completion tracking mechanisms to include an ability to classify a tag as being invalid if a timeout occurs—e.g., rather than simply reusing the tag after the timeout expires. Tags are identifiers used in PCIe transactions to track requests and completions. By classifying a tag as being invalid after a timeout, some embodiments at least temporarily prevent the reuse of the same tag, which could otherwise potentially lead to security vulnerabilities. This approach helps prevent any pending or incomplete transactions contributing to a compromise to the security of data. Some embodiments thus allow a PCIe port (for example) to maintain both security and availability simultaneously.

Some embodiments additionally or alternatively include an interface for a trusted software module (TSM) and DSM (device security manager) to manage the recovery of invalidated tags. For example, such a TSM or DSM includes or otherwise supports functionality to retrieve and recover the tags once it is secure to do so—e.g., to enable the larger system to eventually return to normal operation without compromising security.

By way of illustration and not limitation, host 202 comprises a tag manager 152, logic of which (e.g., comprising circuit hardware, firmware, executing software and/or any of various suitable combinations thereof) provides functionality to register a tag as being at least temporarily unavailable for use in any communication via a given protected channel. In an embodiment, registry of such a tag (a “prevented tag” herein) is based on an indication that a complete message—which is expected to include, or otherwise correspond to, the tag in question—has failed to be received or otherwise detected before the occurrence of some event, such as the expiration of some threshold amount of time. Such a failure to detect a complete message is variously referred to herein as a “completion timeout event”, “completion timeout” or (for brevity) simply “timeout”.

In some embodiments, tag manager 152 is operable to selectively prevent the use of a tag in communications via an IDE protected channel which extends to a processor core of host 202 and to IO device 106 (e.g., wherein the channel extends both to TDM 101 and to DSM 144). In various embodiments, IO device 106 additionally or alternatively includes logic similar to that of tag manager 152—e.g., wherein such logic is operable to selectively prevent the use of a tag in communications via another protected channel which extends to IO device 106 and to another IO device (not shown) of system 200—e.g., wherein said other protected channel extends to respective DSMs of the IO devices.

Various embodiments additionally or alternatively facilitate a draining of a protected channel—e.g., to assure that any message (of at least one or more message types) which are currently in-flight are drained each to an interface at a respective terminus of the protected channel. In one such embodiment, DSM 144 provides a flush request unit (not shown) which is operable to explicitly request the flushing of one or more protected channels. In some embodiments, a TDM 101 similarly includes a counterpart flush request unit (not shown) to additionally or alternatively request the flushing of a protected channel which facilitates communication between IO device 106 and that TDM 101.

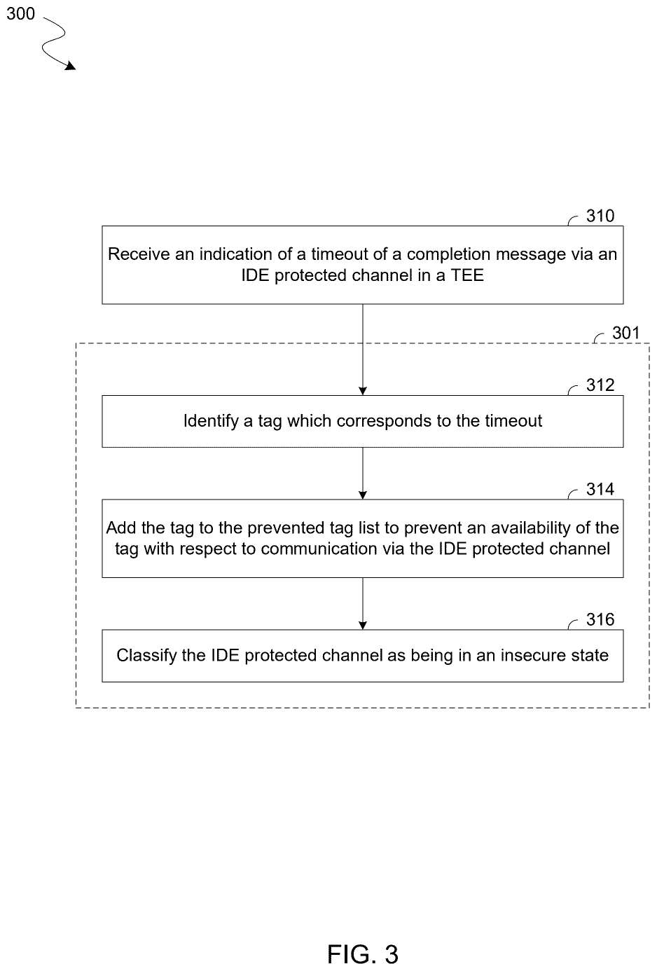

FIG. 3 shows a flow diagram illustrating features of a method 300 to protect IO communications according to an embodiment. Operations such as those of method 300 are performed with any of various combinations of suitable hardware (e.g., circuitry), firmware and/or executing software which, for example, provide some or all of the functionality of computer system 100 or system 200.

As shown in FIG. 3, method 300 comprises (at 310) receiving an indication of a timeout of a completion message which was expected to be communicated via an IDE protected channel in a TEE. In an embodiment, the IDE protected channel extends to each of an IO device and one of a processor core or another IO device. For example, the IDE protected channel extends to a first DSM which is provided with the IO device, and to one of a TSM provided with the core, or a second DSM provided with some other IO device (if any).

In various embodiments, the indication is received at 310 by a root complex or, for example, by a trusted software module (TSM) which is coupled to such a root complex. Communication and/or other provisioning of the indication at 310 includes operations which, for example, are adapted from conventional completion timeout tracking techniques, which are not detailed herein to avoid obscuring certain features of various embodiments.

In some embodiments, method 300 comprises operations 301 which are performed based on the indication which is received at 310. In one such embodiment, operations 301 comprise (at 312) identifying a tag which corresponds to the completion timeout event—e.g., wherein the completion which timed out was expected to include the tag which is identified at 312.

Operations 301 further comprise (at 314) adding the tag to a prevented tag list—also referred to herein as a “dont_use_tag_list” or “DUTL”)—to prevent an availability of the tag with respect to communication via the IDE protected channel. For example, adding the tag to the list at 314 results in said tag being removed from a pool of tags which are available to be selected for inclusion in a given message via the IDE protected channel.

In some embodiments, some or all of method 300 is performed at a root complex or, alternatively, at an IO device which is coupled to a processor core via a root complex. In one such embodiment, an IO device and a processor core are coupled to each other via a root complex which comprises the prevented tag list (and, for example, comprises other circuitry to provide functionality such as that of tag manager 152). In another such embodiment, functionality such as that of tag manager 152 is additionally or alternatively provided at IO device 106a (for example).

In various embodiments, a root port or other suitable resource of a root complex comprises the prevented tag list, which (for example) is able to concurrently list multiple tags each as being unavailable for use via one or more protected channels and/or each as being unavailable for use by one or more IO requestors. By way of illustration and not limitation, a root complex comprises multiple DUTLs which each correspond to a different respective one or more protected channels. Alternatively or in addition, some or all such multiple DUTLs each correspond to a different respective one or more IO requestors, for example.

Although some embodiments are not limited in this regard, operations 301 further comprise (at 316) classifying the IDE protected channel as being in an insecure state—e.g., by changing a classification of the channel to initiate or otherwise cause one or more attack prevention, attack response and/or attack mitigation measures. In one such embodiment, the classifying at 316 is based on an occupancy of the prevented tag list reaching or exceeding some threshold amount due to the tag being added at 314. For example, the classifying at 316 is performed based on the prevented tag list having at least one tag listed and, in some embodiments, having more than one tags listed. In some embodiments, the classifying at 316 is performed based on the adding at 314 resulting in an overflow of the prevented tag list.

In some embodiments, method 300 further comprises one or more additional operations (not shown) which enable a given tag to again be available for use—e.g., where it is determined, for example, that a previously indicated completion timeout has been determined to be “benign” (e.g., having a cause other than a malicious agent). In one such embodiment, method 300 further comprises receiving a second indication that the timeout indicated at 310 is benign. Based on the second indication, method 300 subsequently removes from the prevented tag list the tag which was added at 314. In some embodiments, method 300 (re)classifies the IDE protected channel as being in a secure state based on the second indication.

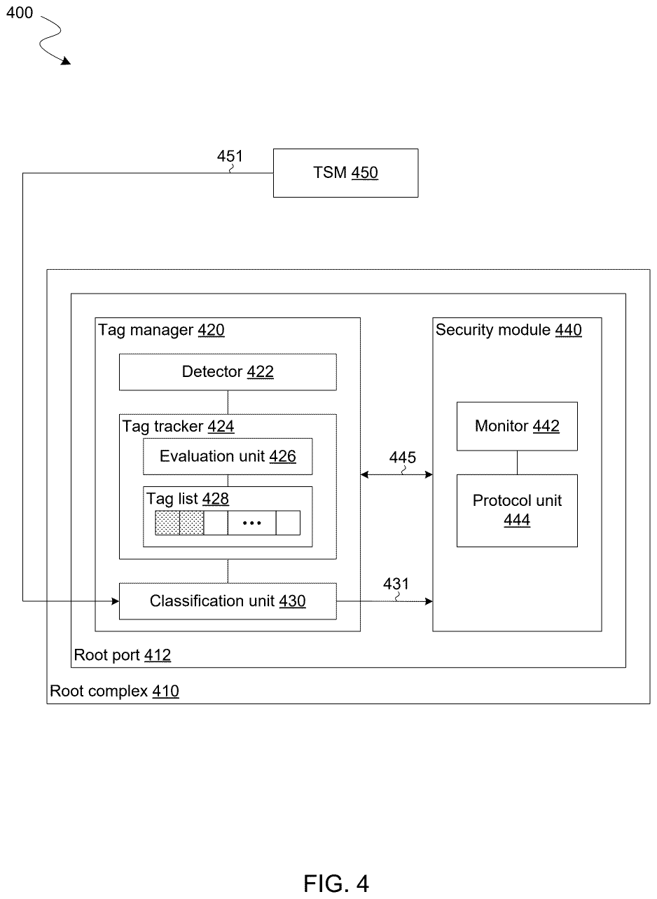

FIG. 4 shows an integrated circuit (IC) 400 which selectively prevents the use of a tag associated with a completion timeout. IC 400 illustrates features of one embodiment wherein a prevented tag list is maintained—at a root complex, for example—to track which tags (if any) are to be unavailable for use in communications via a protected channel. In some embodiments, IC 400 provides functionality such as that which is provided with computer system 100 or system 200—e.g., wherein operations of method 300 are performed with some or all of IC 400.

As shown in FIG. 4, IC 400 comprises a TSM 450 and a root complex 410 which is communicatively coupled thereto—e.g., wherein TSM 450 is provided with a processor core (such as core 102a, for example) and wherein root complex 410 includes some or all features of root complex 150. Root complex 410 provides functionality to receive or otherwise detect an indication of a completion timeout. When a completion is lost—e.g., due to misrouting in the PCIe (or other) interconnect fabric—it is detected as an integrity error on a corresponding IDE channel, causing the registration of a prevented tag and (for example) a transition of the IDE channel to an insecure state.

In the example embodiment shown, a root port 412 of root complex 410 comprises a tag manager 420 (such as tag manager 152) and a security module 440. Security module 440 is operable to support protected communications via an IDE channel which, for example, extends to the processor core that provides TSM 450 and, in an embodiment, further extends to an IO device (not shown). By way of illustration and not limitation, security module 440 comprises a protocol unit 444 which is coupled to support and/or otherwise detect communications in the IDE protected channel. Furthermore, security module 440 comprises a monitor 442 which monitors for one or more types of events including (for example) completion message events, completion timeout events, and/or the like.

In an embodiment, tag manager 420 includes, is coupled to, or otherwise operates based on, a detector 422 which is operable to participate in communications 445 with security module 440 (e.g., with monitor 442), whereby monitor 442 receives, generates or otherwise detects an indication of a completion timeout. In one such embodiment, a tag tracker 424 of tag manager 420 is coupled to prevent an availability of a tag list based on the completion timeout detected by detector 422. For example, tag tracker 424 includes an evaluation unit 426 for identifying a tag as corresponding to the completion timeout which communications 445 indicates to detector 422. In various embodiments, tag tracker 424 adds a tag, which was identified by evaluation unit 426, to a tag list 428—i.e., a list of one or more tags which are to be made at least temporarily unavailable for communications via the IDE protected channel. While a given tag is include in tag list 428, said tag is omitted from a pool of available tags for the IDE protected channel. For example, tag list 428 is able to list up to only one tag at a given time or, alternatively, anywhere between zero tags and some plurality of tags at a given time. In various embodiments, tag manager 420 includes multiple prevented tag lists which each correspond to a different respective protected channel and/or to a different respective IO requestor.

In various embodiments, tag manager 420 further includes, or is coupled to operate with, a classification unit 430 which provides functionality to selectively (re)classify a given IDE protected channel based on a current occupancy state of a corresponding prevented tag list. For example, classification unit 430 is coupled to determine whether (or not) an occupancy of tag list 428 meets or exceeds some predetermined test condition. Based on such a determination, classification unit 430 classifies a corresponding IDE protected channel as being in any of various states including, for example, an unsecure state, a secure (working) state, and/or the like. By way of illustration and not limitation, classification unit 430 generates a signal 431 to selectively enable—or disable—one or more attack prevention, attack response and/or attack mitigation measures (e.g., at security module 440). Although some embodiments are not limited in this regard, TSM 450 provides signal 451 which configure how classification unit 430 is to determine a particular channel classification based on a particular one or more tag list occupancy criteria.

Some embodiments extend or otherwise adapt functionality of a PCIe IDE specification, which uses an Advanced Encryption Standard-Galois Counter Mode (AES-GCM) functionality for securing data. In one such embodiment, each transmitter and receiver of a completion packet maintains an AES-GCM counter. If a completion is misrouted by the PCIe fabric, it will cause an AES counter mismatch between the transmitter and receiver, leading to an integrity error on the IDE.

Some embodiments variously accommodate the possibility of one or more additional or alternative cases of completion timeouts—e.g., such as those caused by malicious switches delaying a completion, or small completion timer values—similarly being treated as integrity errors.

In one example, AES-GCM operation is used to provide a counter mode encryption of data and a message authentication code for the data. For example, counter mode encryption uses symmetric key cryptographic block ciphers. Generally, a block cipher is an encryption algorithm that uses a symmetric key to encrypt a block of data in a way that provides confidentiality or authenticity. A counter mode of operation turns a block cipher into a stream cipher. An input block, which is an initialization vector (IV) concatenated with a counter value, is encrypted with a key by a block cipher. The output of the block cipher is used to encrypt (e.g., by an XOR function) a block of plaintext to produce a ciphertext. Successive values of the IV and counter value are used to encrypt successive blocks of plaintext to produce additional blocks of ciphertext.

In addition to producing ciphertext from input data, GCM operation also calculates a Galois message authentication code (GMAC). A GMAC, which is one example of what is more generally referred to herein as a “tag” or “authentication tag”, comprises (for example) a few bytes of information used to authenticate a message or transaction.

In various embodiments, a PCIe requestor (or other suitable resource) maintains a list of tags that cannot be used by placing the timed-out non-posted request tags in a dont_use_tag_list. In one such embodiment, a size of a dont_use_tag_list is able to vary over time between zero (0) and some predetermined maximum possible number of tags. In an illustrative scenario according to one embodiment, when the size of such a list is zero, a protected channel—e.g., an IDE channel—which corresponds to the list is classified as being in a state (a “secure state” or “work state”) which, for example, corresponds to relatively easy communication via the channel. By contrast, the channel is subject to being transitioned to an “insecure state” classification based on the detection of a completion timeout that results in a corresponding tag being added to the list. As compared to the secure state classification, the insecure state classification results in the channel being prevented or otherwise relatively constrained—e.g., wherein the one or more channel protection mechanisms are enabled based on the insecure state classification.

In various embodiments, a prevented tag list corresponds to one (and, for example, only one) IO requestor and/or corresponds to one (and, for example, only one) channel. By way of illustration and not limitation, a root complex includes multiple prevented tag lists which each correspond to a different respective IDE and/or which each correspond to a different respective requestor, in some embodiments.

In an illustrative scenario according to one embodiment, an orphaned completion arrives at, or is otherwise detected by, a resource (such as one at a root complex) which manages tag invalidation. For example, the orphaned completion is detected while the size of a corresponding prevented tag list is greater than zero (or some other predetermined threshold minimum number of invalidated tags). Based on the list exceeding such a threshold, some embodiments treat the detected orphaned completion as being an indication of an attack, and transition the channel in question to an insecure state—e.g., to prevent some or all communication via the channel and/or to apply one or more additional security mechanisms to some or all communication via the channel.

In some embodiments an IDE channel transitions to insecure based on the first detection of a completion timeout of a non-posted request that was sent on that IDE channel. In other embodiments, it is not acceptable to immediately transition a channel to insecure state (for example, in a SRIOV case). In some of these cases, when the size of a dont_use_tag_list is nonzero, the root port waits for the list to overflow, whereupon hardware automatically transitions the IDE channel to an insecure state and, in some embodiments, frees the tag which has overflowed from the list. Although FIG. 4 shows root port and TSM, in other embodiments, the same mechanism are implemented at a device endpoint—e.g., with a DSM of said device endpoint.

In some embodiments, a TSM signals for the dynamic release of a tag from a prevented tag list after the TSM acquires some sufficient evidence that the completion timeout, which corresponds to said tag, was not due to security attack. In some example embodiments, to handle timeouts, a root port logs NP request headers that have timed out in internal registers. For example, the size of the logged timed-out headers can range from 1 to a maximum number of tags. In one such embodiment, if the log overflows due to an excessive number of completions timeouts, then the root port generates signals indicating an attack, whereupon the IDE channel in question is transitioned to an insecure state.

In some embodiments, before freeing a given tag from a dont_use_tag_list, a TSM needs to confirm that all completions generated by a given TDI have reached the root port. In one such embodiment, the TSM is able to access and use a root port receiver side resource (e.g., including a IDE Rx CPL AES GCM IV Counter) to verify that all completion packets transmitted by a given TDI have been received after said TDI was stopped.

In various embodiments, each packet communicated in a given IDE protected channel, including completion packets, has a unique sequence number that increments with each new packet sent. Cryptographic functionality is supported with an initialization vector (IV) counter which comprises two components: the packet sequence number and the subpacket count. In one such embodiment, the IV is 128 bits, with the lower 32 bits comprising the subpacket component and the upper 96 bits comprising the packet sequence number, which increments with each new packet sent. By synchronizing the packet sequence number between transmitter and receiver, a DSM and a TSM are able to confirm that a last packet sent has been received. In the case of a TDI, the last packet is (for example) a packet that is sent when the TDI is stopped. In the case of a root port, the last packet sent is (for example) the packet that is sent before the MMIO was unmapped.

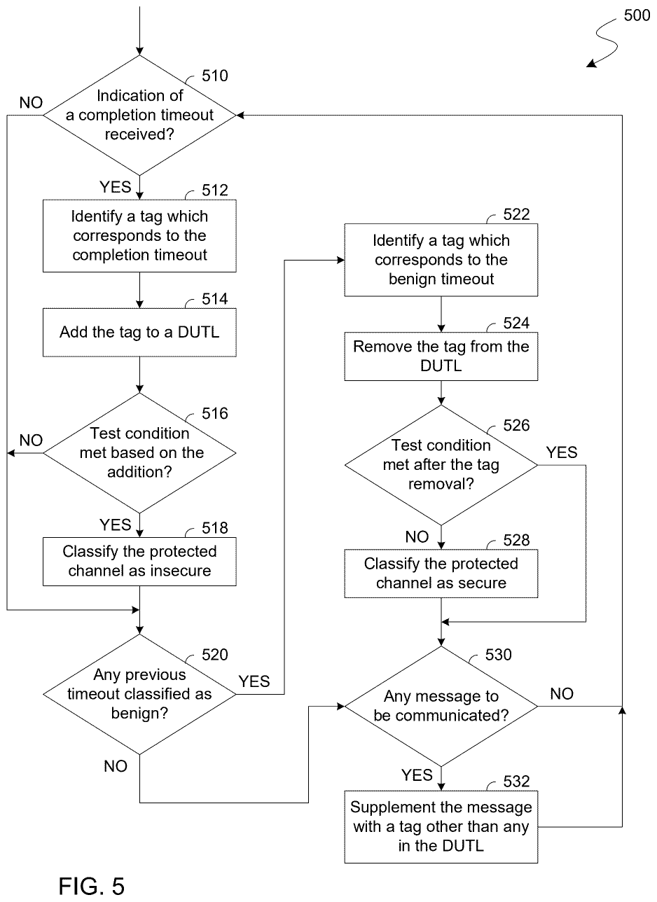

FIG. 5 shows a method 500 for mitigating security risks to communications in a TEE according to an embodiment. Method 500 illustrates one example of an embodiment wherein one or more tags are designated as being unavailable for use in the communication of messages in a protected channel. Operations such as those of method 500 are performed with any of various combinations of suitable hardware (e.g., circuitry), firmware and/or executing software which, for example, provide some or all of the functionality of computer system 100, systems 200, or IC 400—e.g., wherein operations of method 500 include or are otherwise based on method 300.

As shown in FIG. 5, method 500 comprises performing an evaluation (at 510) to detect whether an indication of a next completion timeout has been received. Where it is determined at 510 that an indication of a next completion timeout has not been received, method 500 performs an evaluation (at 520) to determine—as described below—whether any previously indicated completion timeout has been classified as being benign.

Where it is instead determined at 510 that such an indication has been received, method 500 (at 512) identifies a tag which corresponds to the indicated completion timeout. Furthermore, method 500 (at 516) adds the tag to a dont_use_tag_list (DUTL). Subsequently, method 500 performs an evaluation (at 516) to determine whether a test condition—e.g., including a threshold list occupancy condition—has been met by the most recent addition of the tag to the DUTL at 514. In some embodiments, the test condition includes the DUTL currently including at least some minimum threshold number of prevented tags—e.g., wherein the minimum threshold number is equal to one. In various embodiment, the test condition includes the DUTL currently being full. In one such embodiment, the test condition further comprises an instance of the DUTL overflowing (e.g., wherein an oldest tag in the DUTL is evicted) due to the adding at 514.

Where it is determined at 516 that the test condition has not been met based on the addition, method 500 performs the evaluation at 520 to detect for any recent detection of a benign completion timeout. In this particular context, “benign” refers to the characteristic of a completion timeout being identified as not being caused, by or otherwise associated with, any attack by a malicious agent. Where it is instead determined at 516 that the test condition has been met based on the most recent addition at 514, method 500 (at 518) classifies the protected channel as being insecure, before performing the evaluation at 520.

Where it is determined at 520 that no additional previous completion timeout been classified as benign, method 500—as described below—performs an evaluation (at 530) to determine whether any message is scheduled, pending or otherwise expected to be communicated via the protected channel.

Where it is instead determined at 520 that some previous completion timeout been classified as benign, method 500 (at 522) identifies a tag which corresponds to the benign timeout in question. Furthermore, method 500 (at 524) removes the tag in question from the DUTL. Further still, method 500 performs an evaluation (at 526) to determine whether the test condition is met after the most recent tag removal at 524.

Where it is determined at 526 that the test condition is met after the most recent tag removal at 524, method 500 performs the evaluation (at 530) to determine whether any message is expected to be communicated via the protected channel. Where it is instead determined at 526 that the test condition is no longer met after the most recent tag removal at 524, method 500 (at 528) classifies the protected channel as being in a secure state, in addition to performing the evaluation at 530.

Where it is determined at 530 that no message is expected to be communicated via the protected channel, method 500 performs a next instance of the evaluating at 510. Where it is instead determined at 530 that at least some message is to be communicated via the protected channel, method 500 (at 532) supplements the message in question with a tag other than any of the one or more tags (if any) which are currently included in the DUTL. Subsequently, method 500 performs a next instance of the evaluating at 510.

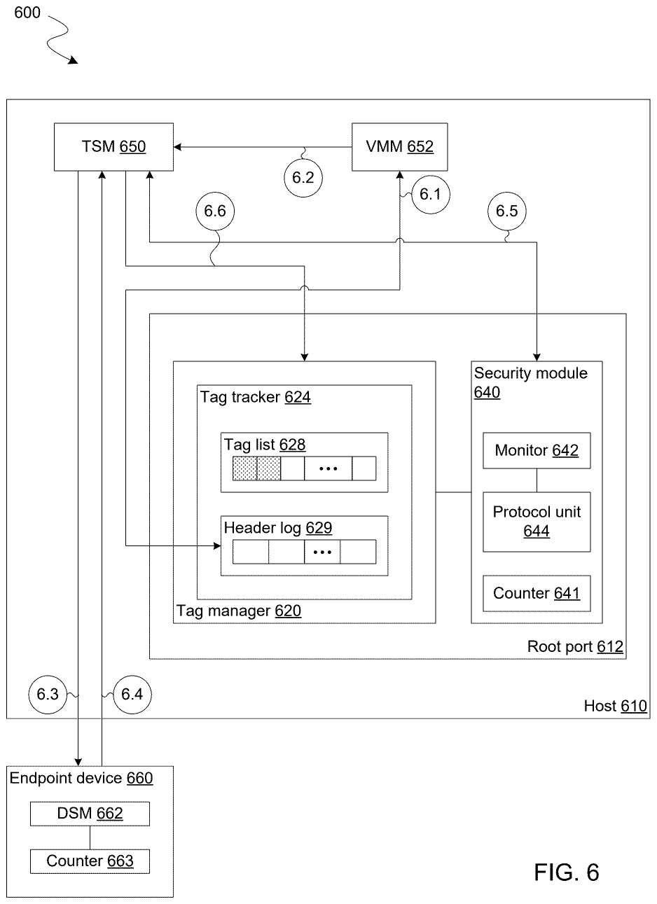

FIG. 6 shows a system 600 which protects communications in a TEE according to an embodiment. System 600 illustrates features of one example embodiment wherein a prevented tag list is used to selectively make one or more tags unavailable for use in communication via a channel which, for example, is integrity protected and/or cryptographically protected. In some embodiments, system 600 provides functionality such as that of computer system 100, system 200 or IC 400—e.g., wherein operations of method 300 or method 500 are performed with some or all of system 600.

As shown in FIG. 6, system 600 comprises a host 610 and an endpoint device 660 which is coupled thereto—e.g., wherein host 610 and endpoint device 660 correspond functionally to host 202 and IO device 106 (respectively). Host 610 comprises a root port 612 and a processor core (not shown)—such as one of cores 102—which provides both a TSM 650 and a VMM 652. In one such embodiment, root port 612 provides functionality of root port 412—e.g., wherein TSM 650 and VMM 652 correspond functionally to TDM 101 and VMM 110b (respectively).

In the example embodiment shown, a security module 640 of root port 612 comprises a monitor 642 and a protocol unit 644 such as monitor 442 and protocol unit 444 (respectively). Furthermore, a tag manager 620 of root port 612 provides functionality such as that of tag manager 420—e.g., wherein a tag tracker 624 of tag manager 620 includes a tag list 628 which (for example) corresponds functionally to tag list 428. Although some embodiments are not limited in this regard, tag tracker 624 further comprise a header log 629 which is used to facilitate a tracking of transaction layer packet (TLP) headers which are communicated via an IDE protected channel.

Operations of some embodiments are variously described herein with respect to various labels for respective sequence numbers which, as listed in the Table 1 below, are communicated each in a corresponding message according to the following:

TABLE 1
Sequence number labels and corresponding labeled messages

| Sequence number | Message corresponding to the sequence number |
|---|---|
| dev_rx_cpl_seq_num | a completion message which an endpoint device has received |
| dev_rx_np_seq_num | a non-posted message which an endpoint device has received |
| dev_tx_cpl_seq_num | a completion message which an endpoint device has transmitted |
| dev_tx_np_seq_num | a non-posted message which an endpoint device has transmitted |
| rp_rx_cpl_seq_num | a completion message which a root port has received |
| rp_rx_np_seq_num | a non-posted message which a root port has received |
| rp_tx_cpl_seq_num | a completion message which a root port has transmitted |
| rp_tx_np_seq_num | a non-posted message which a root port has transmitted |

As shown in FIG. 6, system 600 extends and/or otherwise adapts PCIe TDISP functionality and DSM functionality to facilitate the provisioning of sequence numbers dev_tx_cpl_seq_num and dev_tx_np_seq_num (upper 96 bits of the IV counter) in a STOP_INTERFACE_RESPONSE message (e.g., a PCIe TDISP Message). In one such embodiment, TSM 650 ensures that sequence number rp_rx_cpl_seq_num in root port 612 is greater than or equal to a corresponding sequence number dev_tx_cpl_seq_num before a corresponding tag is removed from tag list 628.

In an illustrative scenario according to one embodiment, a completion timeout results in the registration of a prevented tag in tag list 628—e.g., wherein a TLP header which corresponds to the completion timeout is logged to header log 629. Based on a detection of such a completion timeout, VMM 652 participates in communications 6.1 to access the corresponding TLP header in header log 629, and to determine a corresponding trusted device interface (TDI) which, at least in certain conditions, is to be stopped in response to the completion timeout. For example, VMM 652 sends to TSM 650 a message 6.2 which identified the TDI in question as one which is to be stopped.

Based on message 6.2, TSM 650 provides to endpoint device 660 a message 6.3—e.g., a STOP_INTERFACE_REQ (rp_tx_np_seq_num) message—requesting that that the identified TDI be stopped. Based on communication 6.3, a DSM 662 of endpoint device 660 evaluates an AES GCM CPL Tx/NP Rx counter 663 to determine—as a condition for stopping the TDI in question—whether a sequence number dev_rx_np_seq_num of counter 663 is greater than or equal to the sequence number rp_tx_np_seq_num in message 6.3. This evaluation is to check that there are no non-posted requests blocked in the switch fabric which is used by the IDE protected channel. Where DSM 662 determines that there are no non-posted requests blocked in the switch fabric, endpoint device 660 stops the TDI at endpoint device 660, and sends a message 6.4—e.g., a STOP_INTERFACE_RSP (dev_tx_cpl_seq_num)—to confirm to TSM 650 that the TDI is stopped.

Subsequently, TSM 650 participates in communications 6.5 with security module 640 for evaluating an AES GCM CPL Rx/NP Tx counter 641 to determine whether a sequence number rp_rx_cpl_seq_num is greater than or equal to the sequence number dev_tx_cpl_seq_num in message 6.4. This evaluation is performed to confirm that all completions generated by the TDI have reached the root complex on receiving communication 6.4. Where it is determined that all completions from the TDI are drained to the root port, and that the TDI is in a stopped state, TSM 650 participates in communications 6.6 with tag manager 620 to check an address in the logged TLP header which corresponds to the TDI in question. Furthermore, communications 6.6 signal to tag tracker 624 that the corresponding tag is to be removed from tag list 628.

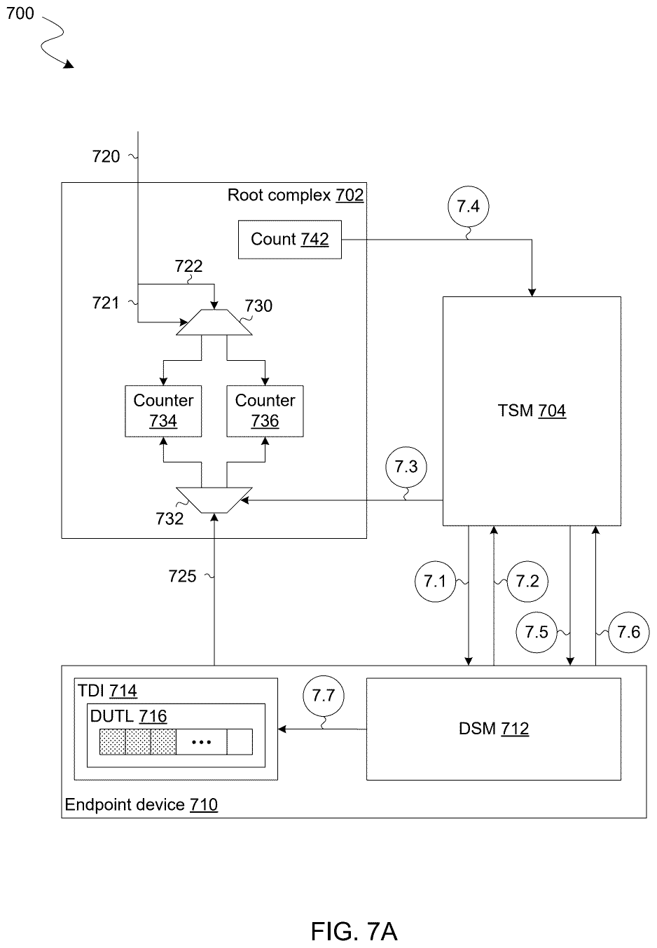

FIG. 7A shows a system 700 which provides protections for communications in a TEE according to an embodiment. System 700 illustrates one embodiment wherein prevented tag list functionality is provided at an endpoint device such as any of various suitable IO devices (e.g., memory devices). In some embodiments, system 700 provides functionality such as that of computer system 100, system 200, IC 400, or system 600—e.g., wherein operations of method 300 or method 500 are performed with some or all of system 700.

As shown in FIG. 7A, system 700 comprises a root complex 702, a TSM 704, and an endpoint device 710 which (for example) correspond functionally to root complex 150, TDM 101a, and IO device 106a, respectively. In the example embodiment shown, root complex 702 comprises multiplexer (MUX) circuits 730, 732 to facilitate the maintaining of multiple counters—such as the illustrative counters 784, 786 shown—which each correspond to a different respective epoch. A DSM 712, provided with endpoint device 710, is operable to manage a TDI 714 which (for example) is at a terminus of an IDE protected channel. In an embodiment, a prevented tag list DUTL 716 is used as a registry of one or more tags (if any) which are to be unavailable for use in communications via the IDE protected channel.

System 700 illustrates an embodiment which is capable of accommodating various scenarios wherein a completion timeout occurs on the trusted device interface (TDI), and wherein a similar technique is used, with a TSM and/or a DSM, to obtain evidence (referred to as “proof” herein) that the timeout is not due to a security attack. In the case of SRIOV, when one TDI times out, it is possible that other TDIs may still be running. Therefore, to ensure that all non-posted requests from the TDI are indeed complete after the TDI is stopped, a root port according to some embodiments implements a counter that counts the number of pending non-posted requests received on the IDE stream. Some embodiments provide two or more such counters, each for a different respective epoch.

In the example embodiment shown, root complex 702 (or, for example, a processor core) tracks an epoch of incoming non-posted requests so that a given completion can be matched to the correct epoch and the correct non-posted request counter can be decremented. For example, a signal 720 indicating a completion comprises a portion 721 which (for example) indicates a corresponding tag, epoch and/or other metadata. MUX circuit 730 is coupled to selectively decrement either of counters 784, 786 based on another portion 722 of signal 720, wherein the counter in question is selected with portion 721.

TSM 704 is coupled to send to endpoint device 710 a message 7.1—e.g., STOP_INTERFACE_REQ(rp_tx_np_seq_num)—to request that TDI 714 be stopped. Subsequently, endpoint device 710 sends a message 7.2—e.g., STOP_INTERFACE_RSP(dev_tx_cpl_seq_num, dev_tx_np_seq_num)—to confirm to TSM 704 that TDI 714 has been stopped. Based on message 7.2, TSM 704 performs an evaluation to determine whether a corresponding sequence number rp_rx_np_seq_num is greater than or equal to the sequence number dev_tx_np_seq_num provided by DSM 712—e.g., to determine whether last non-posted message sent by TDI 714 is received in the root port which includes root complex 702.

Based on said evaluation, TSM 704 generates a message 7.3 with which MUX circuit 732 is operated to increment the corresponding one of counters 784, 786 based on a signal 725 (such as a non-posted request from endpoint device 710 via the IDE protected channel). For example, TSM 704 increments the counter which corresponds to the epoch in question, and waits for the non-posted requests received in the previous epoch (np_req_counter) to drain from the protected IDE channel. In an embodiment, such draining is indicated by a message 7.4 which provides the value of a count 742 of non-posted requests at root complex 702. Since TDI 714 was stopped in a previous epoch, once the previous epoch has drained, it serves as proof that there are no outstanding requests from TDI 714 pending in the interconnect fabric (not shown). As a result, TSM 704 can safely unbind the TDI 714 from a TVM.

In an illustrative scenario according to one embodiment, TDI 714 may need to be rebound at some later point in time. In one such embodiment, TSM 704 sends to DSM 712 a message 7.5—e.g., LOCK_INTERFACE_REQ(rp_tx_cpl_seq_num)—to request that TDI 714 be locked to a particular IDE protected channel. Based on message 7.6 DSM 712 performs an evaluation to determine whether a sequence number dev_rx_cpl_seq_num is greater than or equal to the sequence number rp_tx_cpl_seq_num provided by TSM 704. Such an evaluation ensures that all the completions from the root complex 702 have reached endpoint device 710 and are not in the interconnect fabric. Where the evaluation has a positive result, TDI 714 is locked, and endpoint device 710 sends to TSM 704 a confirming response message 7.6—e.g., LOCK_INTERFACE_RSP(success). Furthermore, DSM 712 sends a message 7.7 for TDI 714 to free a corresponding tag from DUTL 716.

FIG. 7B shows a system 750 which facilitates protection of a TEE according to another embodiment. System 700 illustrates one example embodiment wherein a resource (e.g., a root port) at a root complex—as part of operations which maintain, update or otherwise access a prevented tag list—generates a request to flush an IDE-protected channel. As detailed herein, some embodiments variously enable either or each of a TSM and a DSM to generate an explicit request to flush an IDE-protected channel—e.g., in addition to, or instead of, some or all such embodiments providing functionality of a prevented tag list.

In the example embodiment shown, system 750 comprises a root complex 752 and an endpoint device 760 which is coupled thereto. Root complex 752 and endpoint device 760 provide functionality such as that of root complex 702 and endpoint device 710 (respectively)—e.g., wherein counters 784, 786, and MUX circuits 780, 782 of root complex 752 correspond functionally to counters 734, 736, and MUX circuits 730, 732 (respectively). In one such embodiment, MUX circuit 780 is coupled to operate based on signal 770 comprising potions 771, 772 which (for example) correspond to portions 721, 722, respectively. Furthermore, endpoint device 760 comprises a DSM 762 and a TDI 764 (such as DSM 712 and TDI 714), wherein a DUTL 766 of TDI 764 corresponds functionally to DUTL 716—e.g., wherein a signal 775 from endpoint device 760 to MUX circuit 782 corresponds functionally to signal 725.

In an illustrative scenario according to one embodiment, a root port 754 of root complex 752 is coupled to send to endpoint device 760 a message 7.11—e.g., a STOP_INTERFACE_REQ having some or all features of message 7.1—to request that TDI 764 be stopped. Based on message 7.11, DSM 762 sends to root port 754 a message 7.12 which comprises a non-posted flush request (FLUSH_REQ) message—e.g., a request to flush an IDE-protected channel which, for example, extends to endpoint device 760 (and, for example, to the TDI 764 thereof). In one such embodiment, message 7.12 includes an identifier of endpoint device 760, of the requestor DSM 762, and/or of TDI 764 which is being stopped.

Based on message 7.12, root port 754 performs, initiates or otherwise facilitates one or more operations to flush the IDE-protected channel which extends to endpoint device 760 and, for example, to a processor core (not shown) which provides a TSM. For example, root port 754 sends to MUX circuit 782 a message 7.13 to increment a counter for a corresponding epoch. Subsequently, root port 754 waits for the channel which corresponds to the epoch to be drained, before sending to DSM 762 a flush completion message 7.14 in response to the flush request in message 7.12. In one such embodiment, DSM 762 sends to root port 754 and TDI 764 respective messages 7.15, 7.16 which, for example, correspond functionally to messages 7.6, 7.7 (respectively).

### Explicit Flush Request Functionality

As detailed below, some embodiments additionally or alternatively provide techniques and/or mechanisms for a TSM, a DSM or other suitable logic to explicitly request one or more operations to flush a protected channel in a TEE environment.

In non-TEE case, when VMM unassigns or unbinds the device from old VM to new VM, it is the responsibility of VMM to ensure that no context from old VM is leaked into the new VM. As a part of re-assignment, VMM un-maps an MMIO, un-maps DMA, invalidates core and IO TLBs to disable access to the VM's memory (where the VM also loses access to the device MMIO). Additionally, any in-flight posted writes that may still be present, in the internal or the PCIe fabric are required to be drained to prevent these writes being redirected from the old VM to some new VM when a device is re-assigned to that new VM.

Some embodiments additionally or alternatively provide techniques and/or mechanisms whereby a TSM (or DSM) is to ensure that any in-flight posted transactions are drained before unbinding the TDI from the TVM. Various embodiments support a flush operation with which a TSM and/or an endpoint device (e.g., at least a DSM thereof) explicitly requests that posted transactions are drained—at least in some or all of the scenarios defined below—before a TDI is unbound from one of the TVM or DSM. Some embodiments facilitate an explicit request for a flush of a direct peer-to-peer channel (e.g., a P2P IDE channel) when a TDI is to be unbound from said channel.

Some example scenarios for which various embodiments support the draining of a protected stream include (but are not limited to):
1. TVM to TDI—to ensure that posted MMIO writes from a TVM to a TDI reach the TDI before unbinding,
2. TDI to TVM memory—to ensure that coherent posted DMA writes from a TDI reach destination or global observability before unbinding of the TDI,
3. TDI to TDI (peer2peer through the root complex)—to ensure that non-coherent DMA to a peer memory mapped space reaches the destination before unbinding of a TDI, and
4. TDI to TDI (direct P2P)—to ensure that a non-coherent DMA to a peer memory mapped space reaches the destination before unbinding a TDI from a TVM or unbinding the direct P2P stream of the TDI.

In various embodiments, a flush operation is explicitly requested by one of a TSM or a DSM to drain any in-flight posted writes. Various embodiments utilize such a flush operation to drain in-flight posted MMIO transactions, untranslated posted DMA write transactions, and/or address translation service (ATS) translated direct P2P DMA write transactions before unbinding a TDI from a TVM.

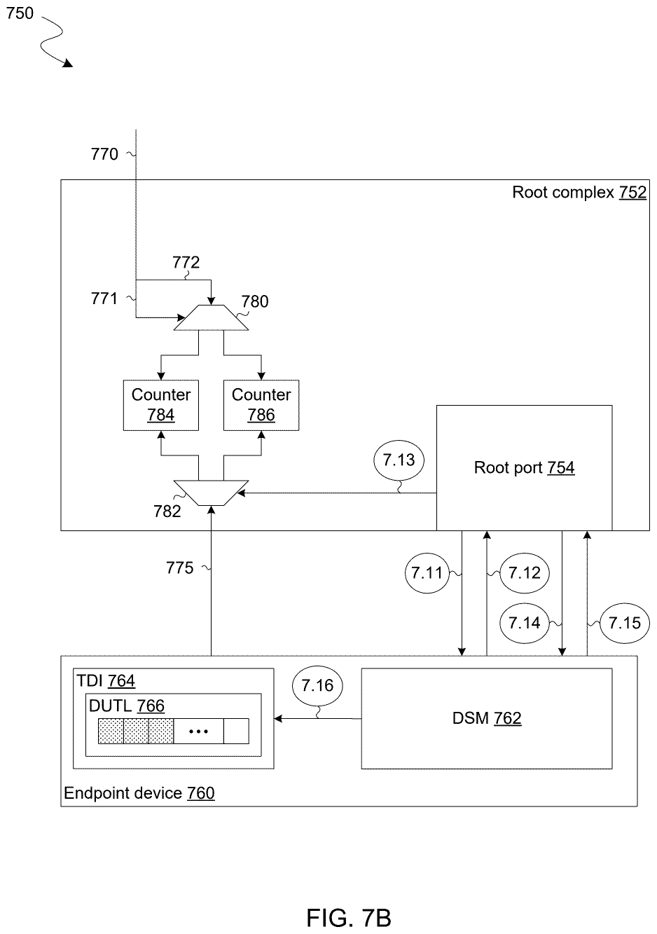

FIG. 8 shows a method 800 for determining a state of a protected channel in a TEE according to an embodiment. Method 800 illustrates one example of an embodiment wherein an agent which is coupled to (and distinguished from) a root port—e.g., the agent including one of a TSM or a DSM—communicates an explicit request to flush a protected channel. Operations such as those of method 800 are performed with any of various combinations of suitable hardware (e.g., circuitry), firmware and/or executing software which, for example, provide some or all of the functionality of computer system 100.

As shown in FIG. 8, method 800 comprises (at 810) participating in communications with one of a TDM or a TSM, wherein the communications are via a root complex, and in an IDE protected channel of a TEE. In an embodiment, the IDE protected channel extends to each of an IO device and one of a processor core or another IO device (if any)—e.g., wherein the IDE protected channel extends both to a first TDM and, via the root complex, to one of a TSM or a second TDM. For example, some or all of method 800 is performed at the IO device (IO device 106a, for example) or, alternatively, at the one of the processor core or the other IO device (e.g., one of core 102a or IO device 106b).

Method 800 further comprises (at 812) sending a request to flush the IDE protected channel. In some embodiments, the request is sent at 812 from the processor core—i.e., wherein the IDE protected channel extends to each of the IO device and the processor core via the root complex which is coupled therebetween. For example, sending the request at 812 to flush the IDE protected channel comprises writing to a flush request register of the root complex. In one such embodiment, the root complex comprises multiple flush request registers which each correspond to a different respective one of multiple IDE protected channels.

In an alternative embodiment, the request at 812 is sent from the IO device to the other IO device—e.g., wherein the IDE protected channel comprises a direct peer-to-peer (P2P) channel and extends to each of the IO device and the other IO device. In one such embodiment, the request to flush the IDE protected channel is sent at 812 based on a second request, from the TSM of the processor core, to stop a trusted device interface or—alternatively—to unbind the trusted device interface.

In response to the request which is sent at 812, method 800 further receives (at 814) a message—from the one of the TSM or the DS—which indicates that a flush of the IDE protected channel has completed. In some embodiments, method 800 further comprises operations (not shown) to determine, based on a state of a trusted device interface (TDI), a number of flush operations to be performed. By way of illustration and not limitation, method 800 determines that only one flush operation is to be requested based on a determination that the TDI in question is in an error state. Alternatively or in addition, method 800 determines that multiple flush operations are requested based on a determination that the TDI is in a run state.

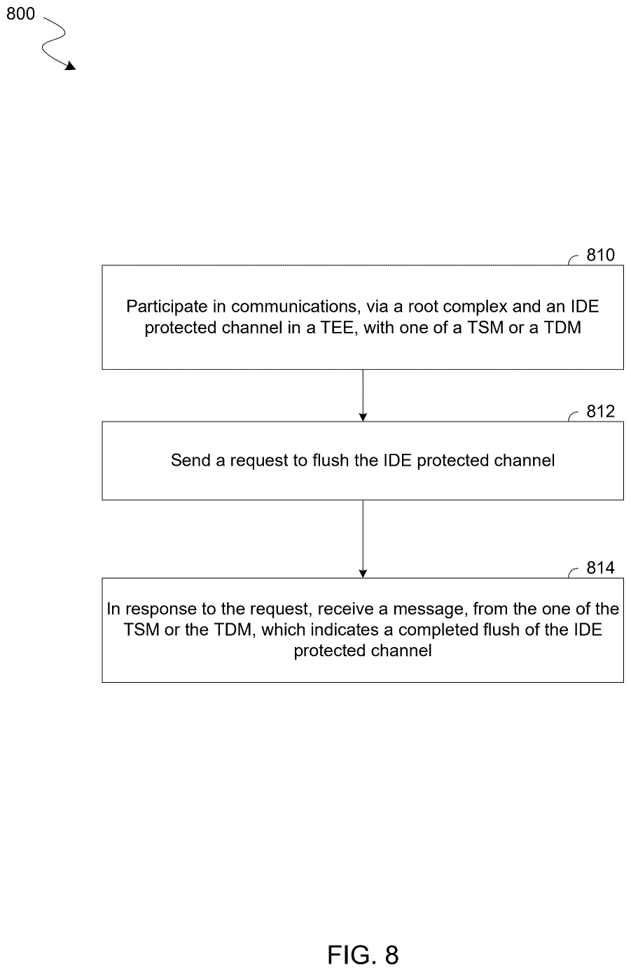

FIG. 9 shows a system 900 which facilitates the protection of communications in a TEE according to an embodiment. System 900 illustrates features of one example embodiment wherein a TSM or a DSM communicate an explicit request to flush some or all currently in-flight messages from a protected stream. In some embodiments, system 900 provides functionality such as that of computer system 100—e.g., wherein operations of method 800 are performed with some or all of system 900.

As shown in FIG. 9, system 900 comprises a TSM 950, an endpoint device 960, and an endpoint device 970 which—for example—provide functionality such as that of TDM 101a, IO device 106a, and IO device 106b (respectively). TSM 950 is provided with a processor core which is coupled to variously communicate with endpoint devices 960, 970 via one or more circuit resources (not shown) including, for example, some or all of an IOMMU, a root complex, and an IO fabric. Endpoint device 960 and endpoint device 970 comprise respective DSMs 962, 972, one or each of which provide functionally of DSM 144 (for example). In an embodiment, endpoint devices 960, 970 are further coupled to enable DSMs 962, 972 to communicate with each other—e.g., via a peer-to-peer (P2P) channel which is independent of the root complex and/or the processor core which provides TSM 950.

In various embodiments, a DSM communicates a request to perform a flush operation for draining a direct P2P channel under any of various scenarios. In one such scenario, a flush request is generated based on (e.g., in response to) a request to unlock a trusted device interface (TDI)—e.g., in preparation for unbinding the TDI from a trusted virtual machine (TVM). For example, such a TDI is at an endpoint device, and facilitates communication between said endpoint device and a core which provides TSM 950.

By way of illustration and not limitation, TSM 950 sends to DSM 962 a message 9.1 (a “STOP_INTERFACE_REQ” message herein) which requests that a trusted device interface (TDI) at endpoint device 960 be unlocked—e.g., in preparation for unbinding the TDI from a trusted virtual machine (or “TVM”, not shown) which is provided by a core which also provides TSM 950. Based on message 9.1, DSM 962 sends to DSM 972 a message 9.2 (a “FLUSH_REQ” message herein) to flush a protected P2P channel by which endpoint devices 960, 970 are coupled to each other. Subsequent to communication of message 9.2, DSM 962 receives from DSM 972 a message 9.3 (a “FLUSH_CPL” message herein) which indicates a completion of a flushing of the P2P channel between endpoint devices 960, 970. For example, message 9.3 indicates to DSM 962 that—for at least one or more message types (e.g., including a posted message type, a write message type and/or the like)—any message(s) of said type(s), which were in-flight when message 9.2 was sent, have completed communication in, or have otherwise been flushed from, the P2P channel between endpoint devices 960, 970. Based on the flush completion indicated by message 9.3, DSM 962 stops or otherwise unlocks a TDI at endpoint device 960, and sends a message 9.4 (a “STOP_INTERFACE_RESPONSE” message herein) to confirm to TSM 950—in response to message 9.1—that the TDI in question has been stopped.

In an alternative scenario, a flush request is generated based on (e.g., in response to) a request to unbind a trusted device interface (TDI) of one IO device from a peer-to-peer (P2P) IDE channel which also extends to another TDI of a peer IO device. By way of illustration and not limitation, TSM 950 sends to DSM 972 a message 9.5 (a “UNBIND_P2P_STREAM_REQ” message herein) which requests that a TDI of endpoint device 970 be unbounded from a peer-to-peer (P2P) IDE channel with another TDI of the peer endpoint device 960. Based on message 9.5, DSM 972 sends to DSM 962 a message 9.6 (a FLUSH_REQ message herein) to flush a protected P2P channel between endpoint devices 960, 970. Subsequent to communication of message 9.6, DSM 972 receives from DSM 962 a message 9.7 (a FLUSH_CPL message) to confirm that the P2P channel between endpoint devices 960, 970 has been flushed. Based on the flush completion indicated by message 9.7, DSM 972 unbinds the TDI of endpoint device 970 from the P2P channel with endpoint device 960, and sends a message 9.8 (a “STOP_INTERFACE_RESPONSE” message herein) to confirm to TSM 950—in response to message 9.5—that said TDI of endpoint device 970 has been so unbound.

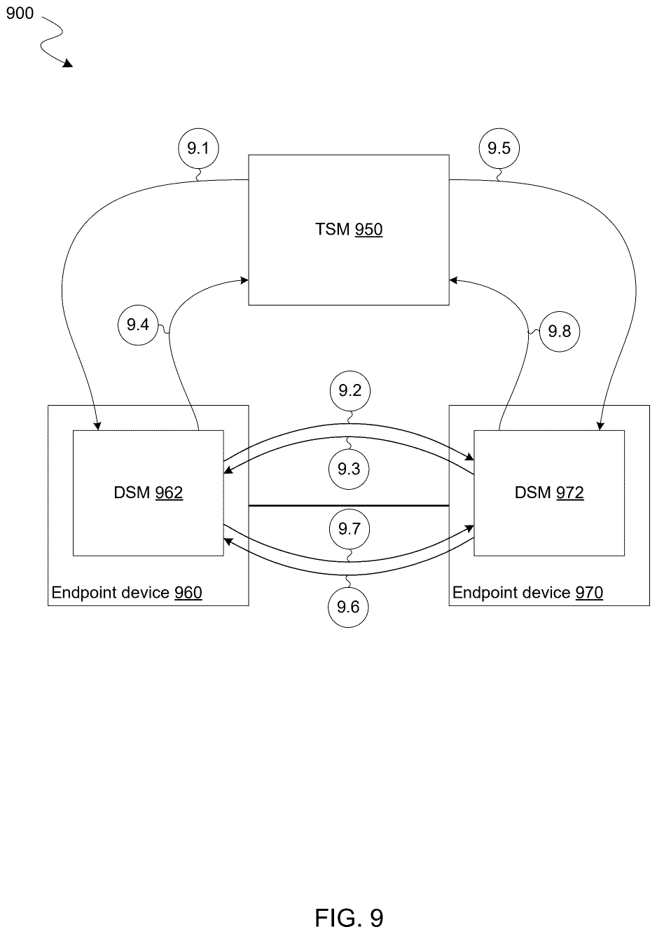

FIG. 10 shows a system 1000 which protects communications in a TEE according to an embodiment. System 1000 illustrates features of one example embodiment wherein a TSM or a DSM communicate an explicit request to flush some or all currently in-flight messages from a protected stream. In some embodiments, system 1000 provides functionality such as that of computer system 100 or system 900—e.g., wherein operations of method 800 are performed with some or all of system 1000.

As shown in FIG. 10, system 1000 comprises a TSM 1050, a root complex 1010, and an IO device 1060 which—for example—provide functionality such as that of TDM 101a, root complex 150, and IO device 106a (respectively). TSM 1050 is coupled to communicate with a DSM 1062 of endpoint device 1060 via root complex 1010 and, in some embodiments, via one or more other resources (not shown) including, for example, an IOMMU, an IO fabric, and/or the like. DSMs 1062 provides functionally of DSM 144 (for example), in an embodiment. Although system 1000 illustrates one embodiment in the context of flush request from a TSM, various embodiment additionally or alternatively support a flush operation being requested by a DSM (e.g., as illustrated in FIG. 9).

In an illustrative scenario according to one embodiment, TSM 1050 sends to root complex 1010 a message 10.1 which writes to a register—illustrated by the one or more flush request (FR) registers 1044 shown—for submitting a flush request. In the example embodiment shown, FR register(s) 1044 are located in a root port 1012 of root complex 1010—e.g., in addition to one or more flush request address (FRA) registers 1045 which are each to provide a respective repository for IDE address information. In some embodiments, root port 1012 comprises multiple FR registers which are each dedicated to a different respective one or more IDE protected channels.

Based on message 10.1, root complex 1010 sends to DSM 1062 a message 10.2 (a FLUSH_REQ message) to flush a protected channel by which endpoint device 1060 communicates with the core which provides TSM 1050. In one such embodiment, DSM 1062 polls FR register(s) 1044 to detect for any flush request from TSM 1050. Based on communication of message 10.2, DSM 1062 sends to root complex 1010 a message 10.3 (FLUSH_CPL message) which is to serve as a confirmation that a flush of the protected channel has been completed. For example, message 10.3 (a FLUSH_CPL message) pushes any posted writes which are in the channel from endpoint device 1060 to root complex 1010. In some embodiments, message 10.3 writes a flush completion indicator to FR register(s) 1044, wherein TSM 1050 subsequently participates in communications 10.4 to read said indicator at FR register(s) 1044.

In some embodiments, a TSM is operable to request only one flush operation or, alternatively, a combination of two (or more) flush operations—e.g., depending on a state of a TDI at a terminus of a protected channel which is to be flushed. By way of illustration and not limitation, if such a TDI is in an Error state, the TSM—in some embodiments—participates in one or more communications to stop said TDI, and then to perform a subsequent flush of the protected channel in question. In one such embodiment, any in-flight posted memory mapped input-output (MMIO) writes will get dropped once they reach the TDI, since (for example) the TDI is configured in an Unlocked state and is not capable to receive trusted MMIO writes. In such a scenario, since the TDI is already stopped, a flush completion message will—in some embodiments—also push any in-flight direct memory access (DMA) posted writes from the TDI in question to the root port.

In an additional or alternative scenario according to some embodiments, a TSM requests a first flush operation—to flush a protected channel which extends to a given TDI—after unmapping a MMIO while said TDI is in a Run (operable) state. In one such case, any in-flight trusted MMIO writes will be drained to the TDI. In various embodiments, the TSM further requests a second flush operation, after stopping the TDI in question, to drain any outgoing posted DMA writes.

Under existing PCIe TDISP specification requirements, PCIe ordering rules are preserved through a IDE channel and message ordering—between posted, non-posted and completion—is ensured. In various embodiments, message re-ordering by a network switch is detected, which causes the IDE channel to transition to an insecure state. In various embodiments, during said insecure state, FLUSH_REQ and FLUSH_CPL TLPs maintain message ordering, wherein any posted writes preceding the FLUSH_REQ and FLUSH_CPL TLPs are drained to the endpoint and root port, respectively. To recover from a scenario where FLUSH_CPL is not received, which prevents an unbinding of a TDI, some embodiments require a protected IDE channel to be disabled.

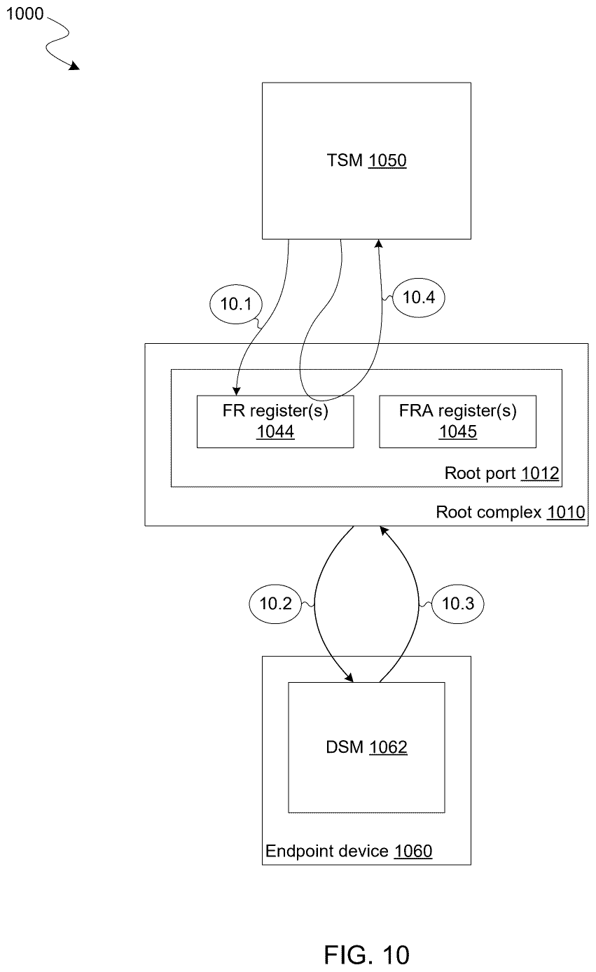

FIG. 11 shows a system 1100 which protects communications in a TEE according to an embodiment. System 1100 illustrates features of one example embodiment wherein a TSM or a DSM communicate an explicit request to flush some or all currently in-flight messages from a protected channel. In some embodiments, system 1100 provides functionality such as that of computer system 100, system 900 or system 1000—e.g., wherein operations of method 800 are performed with some or all of system 1100.

As shown in FIG. 11, system 1100 comprises a TSM 1150, a root complex 1110, an endpoint device 1160, and an endpoint device 1170 which—for example—provide functionality such as that of TDM 101, root complex 150, IO device 106a, and IO device 106b (respectively). A root port 1112 of root complex 1110 comprises one or more flush request (FR) registers 1144 and one or more flush request address (FRA) registers 1145 which, for example, correspond functionally to FR register(s) 1044 and FRA register(s) 1045 (respectively). Endpoint devices 1160, 1170 comprise respective DSMs 1162, 1172 which, for example, correspond functionally to DSMs 962, 972 (respectively). In the illustrative embodiment shown, endpoint device 1160 further comprises one or more FR registers 1164 and one or more FRA registers 1165 which, for example, provide functionality similar to that of FR register(s) 1144 and FRA register(s) 1145 (respectively).

In the example embodiment shown, system 1100 illustrates one embodiment which is operable to perform various communications to implement a combination of multiple channel flush operations. By way of illustration and not limitation, such communications include messages 11.1 through 11.8 which (for example) correspond functionally to messages 9.1 through 9.8 (respectively). Furthermore, such communications include messages 11.9 through 11.12 8 which (for example) correspond functionally to messages 10.1 through 10.4 (respectively). Further still, such communications include communications 11.12 which (for example) correspond functionally to communications 10.4.

### Exemplary Computer Architectures.

Detailed below are describes of exemplary computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

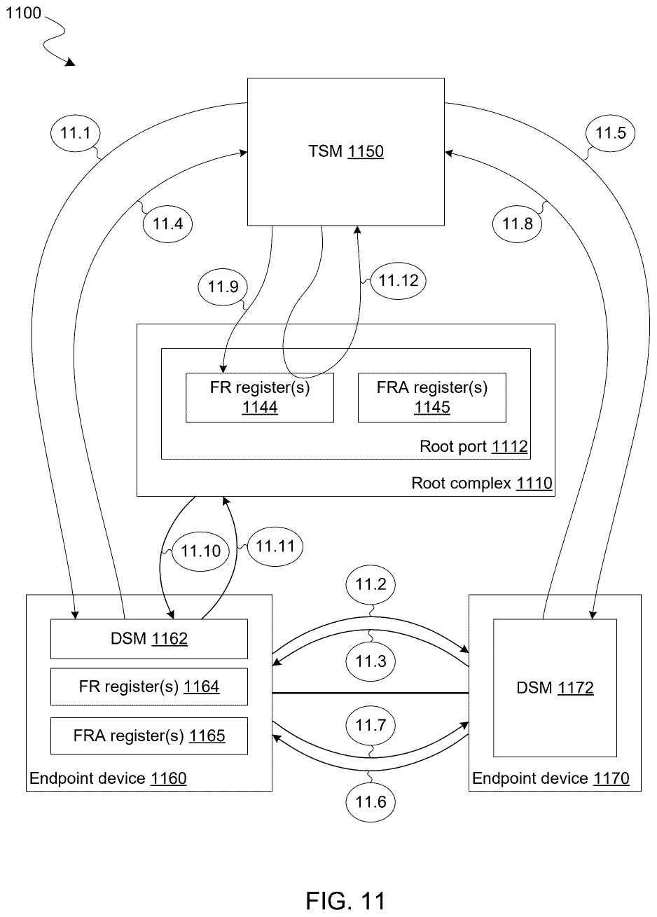

FIG. 12 illustrates an exemplary system. Multiprocessor system 1200 is a point-to-point interconnect system and includes a plurality of processors including a first processor 1270 and a second processor 1280 coupled via a point-to-point interconnect 1250. In some examples, the first processor 1270 and the second processor 1280 are homogeneous. In some examples, first processor 1270 and the second processor 1280 are heterogenous. Though the exemplary system 1200 is shown to have two processors, the system may have three or more processors, or may be a single processor system.

Processors 1270 and 1280 are shown including integrated memory controller (IMC) circuitry 1272 and 1282, respectively. Processor 1270 also includes as part of its interconnect controller point-to-point (P-P) interfaces 1276 and 1278; similarly, second processor 1280 includes P-P interfaces 1286 and 1288. Processors 1270, 1280 may exchange information via the point-to-point (P-P) interconnect 1250 using P-P interface circuits 1278, 1288. IMCs 1272 and 1282 couple the processors 1270, 1280 to respective memories, namely a memory 1232 and a memory 1234, which may be portions of main memory locally attached to the respective processors.

Processors 1270, 1280 may each exchange information with a chipset 1290 via individual P-P interconnects 1252, 1254 using point to point interface circuits 1276, 1294, 1286, 1298. Chipset 1290 may optionally exchange information with a coprocessor 1238 via an interface 1292. In some examples, the coprocessor 1238 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1270, 1280 or outside of both processors, yet connected with the processors via P-P interconnect, such that either or both processors' local cache information may be stored in the shared cache if a processor is placed into a low power mode.

Chipset 1290 may be coupled to a first interconnect 1216 via an interface 1296. In some examples, first interconnect 1216 may be a Peripheral Component Interconnect (PCI) interconnect, or an interconnect such as a PCI Express interconnect or another I/O interconnect. In some examples, one of the interconnects couples to a power control unit (PCU) 1217, which may include circuitry, software, and/or firmware to perform power management operations with regard to the processors 1270, 1280 and/or co-processor 1238. PCU 1217 provides control information to a voltage regulator (not shown) to cause the voltage regulator to generate the appropriate regulated voltage. PCU 1217 also provides control information to control the operating voltage generated. In various examples, PCU 1217 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1217 is illustrated as being present as logic separate from the processor 1270 and/or processor 1280. In other cases, PCU 1217 may execute on a given one or more of cores (not shown) of processor 1270 or 1280. In some cases, PCU 1217 may be implemented as a microcontroller (dedicated or general-purpose) or other control logic configured to execute its own dedicated power management code, sometimes referred to as P-code. In yet other examples, power management operations to be performed by PCU 1217 may be implemented externally to a processor, such as by way of a separate power management integrated circuit (PMIC) or another component external to the processor. In yet other examples, power management operations to be performed by PCU 1217 may be implemented within BIOS or other system software.

Various I/O devices 1214 may be coupled to first interconnect 1216, along with a bus bridge 1218 which couples first interconnect 1216 to a second interconnect 1220. In some examples, one or more additional processor(s) 1215, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 1216. In some examples, second interconnect 1220 may be a low pin count (LPC) interconnect. Various devices may be coupled to second interconnect 1220 including, for example, a keyboard and/or mouse 1222, communication devices 1227 and a storage circuitry 1228. Storage circuitry 1228 may be one or more non-transitory machine-readable storage media as described below, such as a disk drive or other mass storage device which may include instructions/code and data 1230 in some examples. Further, an audio I/O 1224 may be coupled to second interconnect 1220. Note that other architectures than the point-to-point architecture described above are possible. For example, instead of the point-to-point architecture, a system such as multiprocessor system 1200 may implement a multi-drop interconnect or other such architecture.

### Exemplary Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

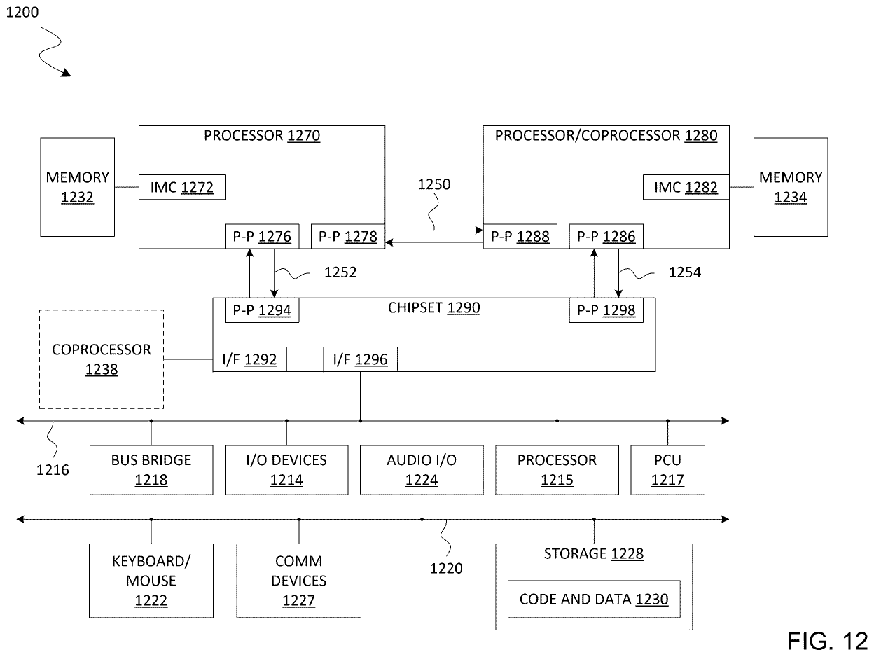

FIG. 13 illustrates a block diagram of an example processor 1300 that may have more than one core and an integrated memory controller. The solid lined boxes illustrate a processor 1300 with a single core 1302A, a system agent unit circuitry 1310, a set of one or more interconnect controller unit(s) circuitry 1316, while the optional addition of the dashed lined boxes illustrates an alternative processor 1300 with multiple cores 1302A-N, a set of one or more integrated memory controller unit(s) circuitry 1314 in the system agent unit circuitry 1310, and special purpose logic 1308, as well as a set of one or more interconnect controller units circuitry 1316. Note that the processor 1300 may be one of the processors 1270 or 1280, or co-processor 1238 or 1215 of FIG. 12.

Thus, different implementations of the processor 1300 may include: 1) a CPU with the special purpose logic 1308 being integrated graphics and/or scientific (throughput) logic (which may include one or more cores, not shown), and the cores 1302A-N being one or more general purpose cores (e.g., general purpose in-order cores, general purpose out-of-order cores, or a combination of the two); 2) a coprocessor with the cores 1302A-N being a large number of special purpose cores intended primarily for graphics and/or scientific (throughput); and 3) a coprocessor with the cores 1302A-N being a large number of general purpose in-order cores. Thus, the processor 1300 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 1300 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1304A-N within the cores 1302A-N, a set of one or more shared cache unit(s) circuitry 1306, and external memory (not shown) coupled to the set of integrated memory controller unit(s) circuitry 1314. The set of one or more shared cache unit(s) circuitry 1306 may include one or more mid-level caches, such as level 2 (L2), level 3 (L3), level 4 (L4), or other levels of cache, such as a last level cache (LLC), and/or combinations thereof. While in some examples ring-based interconnect network circuitry 1312 interconnects the special purpose logic 1308 (e.g., integrated graphics logic), the set of shared cache unit(s) circuitry 1306, and the system agent unit circuitry 1310, alternative examples use any number of well-known techniques for interconnecting such units. In some examples, coherency is maintained between one or more of the shared cache unit(s) circuitry 1306 and cores 1302A-N.

In some examples, one or more of the cores 1302A-N are capable of multi-threading. The system agent unit circuitry 1310 includes those components coordinating and operating cores 1302A-N. The system agent unit circuitry 1310 may include, for example, power control unit (PCU) circuitry and/or display unit circuitry (not shown). The PCU may be or may include logic and components needed for regulating the power state of the cores 1302A-N and/or the special purpose logic 1308 (e.g., integrated graphics logic). The display unit circuitry is for driving one or more externally connected displays.

The cores 1302A-N may be homogenous in terms of instruction set architecture (ISA). Alternatively, the cores 1302A-N may be heterogeneous in terms of ISA; that is, a subset of the cores 1302A-N may be capable of executing an ISA, while other cores may be capable of executing only a subset of that ISA or another ISA.

### Exemplary Core Architectures—In-Order and Out-of-Order Core Block Diagram.

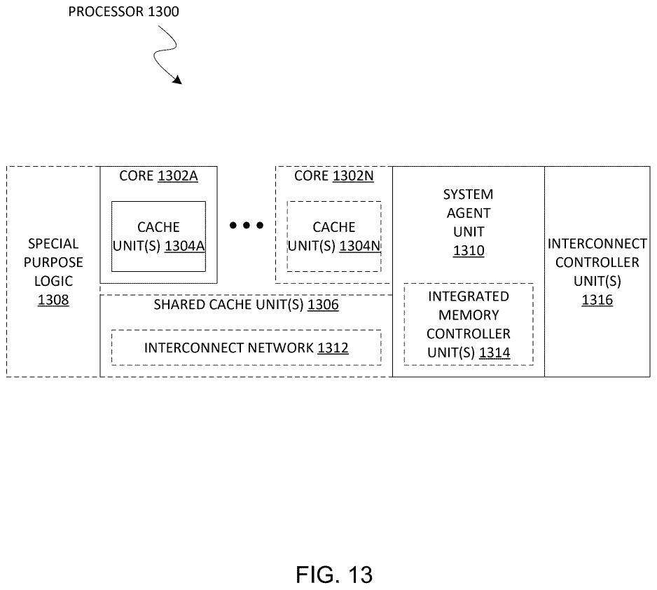

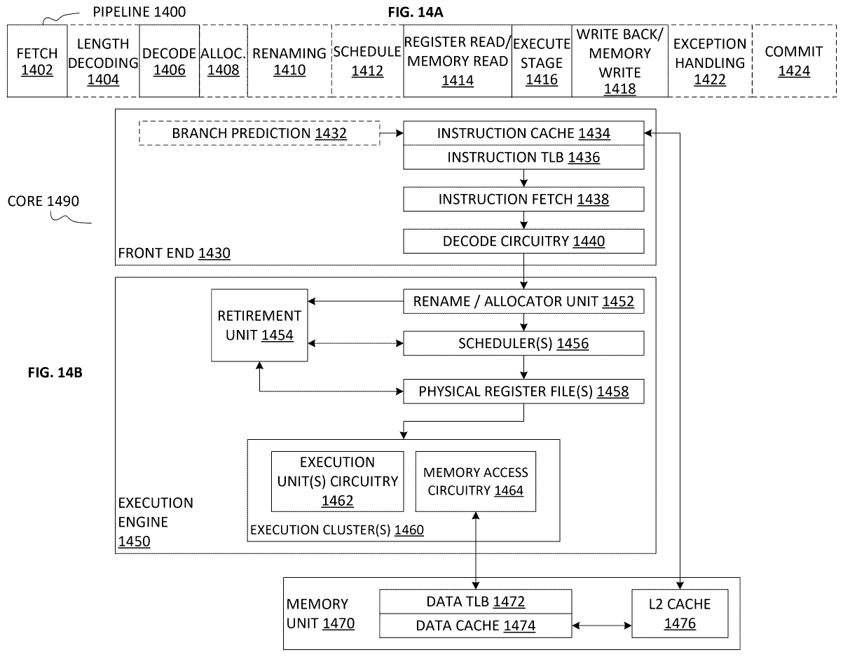

FIG. 14A is a block diagram illustrating both an exemplary in-order pipeline and an exemplary register renaming, out-of-order issue/execution pipeline according to examples. FIG. 14B is a block diagram illustrating both an exemplary example of an in-order architecture core and an exemplary register renaming, out-of-order issue/execution architecture core to be included in a processor according to examples. The solid lined boxes in FIGS. 14A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 14A, a processor pipeline 1400 includes a fetch stage 1402, an optional length decoding stage 1404, a decode stage 1406, an optional allocation (Alloc) stage 1408, an optional renaming stage 1410, a schedule (also known as a dispatch or issue) stage 1412, an optional register read/memory read stage 1414, an execute stage 1416, a write back/memory write stage 1418, an optional exception handling stage 1422, and an optional commit stage 1424. One or more operations can be performed in each of these processor pipeline stages. For example, during the fetch stage 1402, one or more instructions are fetched from instruction memory, and during the decode stage 1406, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1406 and the register read/memory read stage 1414 may be combined into one pipeline stage. In one example, during the execute stage 1416, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 14B may implement the pipeline 1400 as follows: 1) the instruction fetch circuitry 1438 performs the fetch and length decoding stages 1402 and 1404; 2) the decode circuitry 1440 performs the decode stage 1406; 3) the rename/allocator unit circuitry 1452 performs the allocation stage 1408 and renaming stage 1410; 4) the scheduler(s) circuitry 1456 performs the schedule stage 1412; 5) the physical register file(s) circuitry 1458 and the memory unit circuitry 1470 perform the register read/memory read stage 1414; the execution cluster(s) 1460 perform the execute stage 1416; 6) the memory unit circuitry 1470 and the physical register file(s) circuitry 1458 perform the write back/memory write stage 1418; 7) various circuitry may be involved in the exception handling stage 1422; and 8) the retirement unit circuitry 1454 and the physical register file(s) circuitry 1458 perform the commit stage 1424.

FIG. 14B shows a processor core 1490 including front-end unit circuitry 1430 coupled to an execution engine unit circuitry 1450, and both are coupled to a memory unit circuitry 1470. The core 1490 may be a reduced instruction set architecture computing (RISC) core, a complex instruction set architecture computing (CISC) core, a very long instruction word (VLIW) core, or a hybrid or alternative core type. As yet another option, the core 1490 may be a special-purpose core, such as, for example, a network or communication core, compression engine, coprocessor core, general purpose computing graphics processing unit (GPGPU) core, graphics core, or the like.

The front end unit circuitry 1430 may include branch prediction circuitry 1432 coupled to an instruction cache circuitry 1434, which is coupled to an instruction translation lookaside buffer (TLB) 1436, which is coupled to instruction fetch circuitry 1438, which is coupled to decode circuitry 1440. In one example, the instruction cache circuitry 1434 is included in the memory unit circuitry 1470 rather than the front-end circuitry 1430. The decode circuitry 1440 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1440 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1440 may be implemented using various different mechanisms. Examples of suitable mechanisms include, but are not limited to, look-up tables, hardware implementations, programmable logic arrays (PLAs), microcode read only memories (ROMs), etc. In one example, the core 1490 includes a microcode ROM (not shown) or other medium that stores microcode for certain macroinstructions (e.g., in decode circuitry 1440 or otherwise within the front end circuitry 1430). In one example, the decode circuitry 1440 includes a micro-operation (micro-op) or operation cache (not shown) to hold/cache decoded operations, micro-tags, or micro-operations generated during the decode or other stages of the processor pipeline 1400. The decode circuitry 1440 may be coupled to rename/allocator unit circuitry 1452 in the execution engine circuitry 1450.

The execution engine circuitry 1450 includes the rename/allocator unit circuitry 1452 coupled to a retirement unit circuitry 1454 and a set of one or more scheduler(s) circuitry 1456. The scheduler(s) circuitry 1456 represents any number of different schedulers, including reservations stations, central instruction window, etc. In some examples, the scheduler(s) circuitry 1456 can include arithmetic logic unit (ALU) scheduler/scheduling circuitry, ALU queues, arithmetic generation unit (AGU) scheduler/scheduling circuitry, AGU queues, etc. The scheduler(s) circuitry 1456 is coupled to the physical register file(s) circuitry 1458. Each of the physical register file(s) circuitry 1458 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1458 includes vector registers unit circuitry, writemask registers unit circuitry, and scalar register unit circuitry. These register units may provide architectural vector registers, vector mask registers, general-purpose registers, etc. The physical register file(s) circuitry 1458 is coupled to the retirement unit circuitry 1454 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1454 and the physical register file(s) circuitry 1458 are coupled to the execution cluster(s) 1460. The execution cluster(s) 1460 includes a set of one or more execution unit(s) circuitry 1462 and a set of one or more memory access circuitry 1464. The execution unit(s) circuitry 1462 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1456, physical register file(s) circuitry 1458, and execution cluster(s) 1460 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1464). It should also be understood that where separate pipelines are used, one or more of these pipelines may be out-of-order issue/execution and the rest in-order.

In some examples, the execution engine unit circuitry 1450 may perform load store unit (LSU) address/data pipelining to an Advanced Microcontroller Bus (AMB) interface (not shown), and address phase and writeback, data phase load, store, and branches.

The set of memory access circuitry 1464 is coupled to the memory unit circuitry 1470, which includes data TLB circuitry 1472 coupled to a data cache circuitry 1474 coupled to a level 2 (L2) cache circuitry 1476. In one exemplary example, the memory access circuitry 1464 may include a load unit circuitry, a store address unit circuit, and a store data unit circuitry, each of which is coupled to the data TLB circuitry 1472 in the memory unit circuitry 1470. The instruction cache circuitry 1434 is further coupled to the level 2 (L2) cache circuitry 1476 in the memory unit circuitry 1470. In one example, the instruction cache 1434 and the data cache 1474 are combined into a single instruction and data cache (not shown) in L2 cache circuitry 1476, a level 3 (L3) cache circuitry (not shown), and/or main memory. The L2 cache circuitry 1476 is coupled to one or more other levels of cache and eventually to a main memory.

The core 1490 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1490 includes logic to support a packed data instruction set architecture extension (e.g., AVX1, AVX2), thereby allowing the operations used by many multimedia applications to be performed using packed data.

### Exemplary Execution Unit(s) Circuitry.

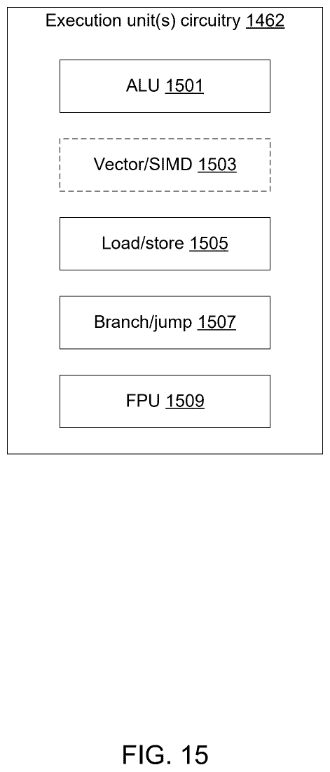

FIG. 15 illustrates examples of execution unit(s) circuitry, such as execution unit(s) circuitry 1462 of FIG. 14B. As illustrated, execution unit(s) circuitry 1462 may include one or more ALU circuits 1501, optional vector/single instruction multiple data (SIMD) circuits 1503, load/store circuits 1505, branch/jump circuits 1507, and/or Floating-point unit (FPU) circuits 1509. ALU circuits 1501 perform integer arithmetic and/or Boolean operations. Vector/SIMD circuits 1503 perform vector/SIMD operations on packed data (such as SIMD/vector registers). Load/store circuits 1505 execute load and store instructions to load data from memory into registers or store from registers to memory. Load/store circuits 1505 may also generate addresses. Branch/jump circuits 1507 cause a branch or jump to a memory address depending on the instruction. FPU circuits 1509 perform floating-point arithmetic. The width of the execution unit(s) circuitry 1462 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Exemplary Register Architecture

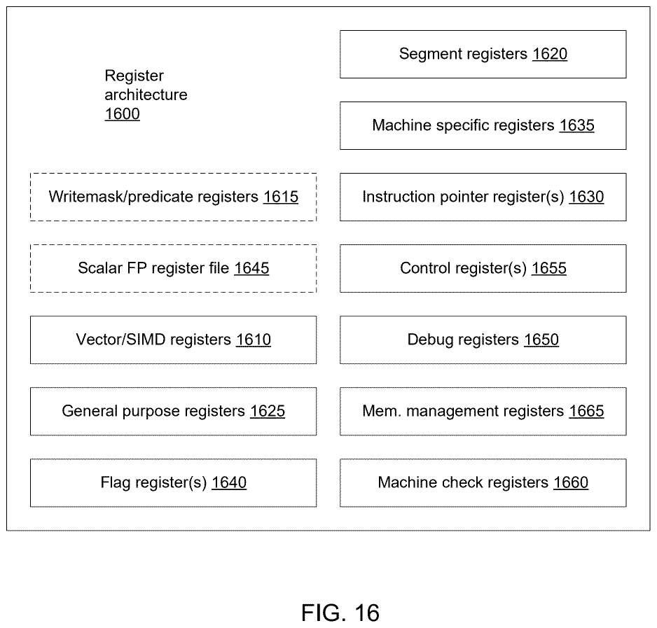

FIG. 16 is a block diagram of a register architecture 1600 according to some examples. As illustrated, the register architecture 1600 includes vector/SIMD registers 1610 that vary from 128-bit to 1,024 bits width. In some examples, the vector/SIMD registers 1610 are physically 512-bits and, depending upon the mapping, only some of the lower bits are used. For example, in some examples, the vector/SIMD registers 1610 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1600 includes writemask/predicate registers 1615. For example, in some examples, there are 8 writemask/predicate registers (sometimes called k0 through k7) that are each 16-bit, 32-bit, 64-bit, or 128-bit in size. Writemask/predicate registers 1615 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1615 corresponds to a data element position of the destination. In other examples, the writemask/predicate registers 1615 are scalable and consists of a set number of enable bits for a given vector element (e.g., 8 enable bits per 64-bit vector element).

The register architecture 1600 includes a plurality of general-purpose registers 1625. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1600 includes scalar floating-point (FP) register 1645 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1640 (e.g., EFLAGS, RFLAGS, etc.) store status and control information for arithmetic, compare, and system operations. For example, the one or more flag registers 1640 may store condition code information such as carry, parity, auxiliary carry, zero, sign, and overflow. In some examples, the one or more flag registers 1640 are called program status and control registers.

Segment registers 1620 contain segment points for use in accessing memory. In some examples, these registers are referenced by the names CS, DS, SS, ES, FS, and GS.

Machine specific registers (MSRs) 1635 control and report on processor performance. Most MSRs 1635 handle system-related functions and are not accessible to an application program. Machine check registers 1660 consist of control, status, and error reporting MSRs that are used to detect and report on hardware errors.

One or more instruction pointer register(s) 1630 store an instruction pointer value. Control register(s) 1655 (e.g., CR0-CR4) determine the operating mode of a processor (e.g., processor 1270, 1280, 1238, 1215, and/or 1300) and the characteristics of a currently executing task. Debug registers 1650 control and allow for the monitoring of a processor or core's debugging operations.

Memory (mem) management registers 1665 specify the locations of data structures used in protected mode memory management. These registers may include a GDTR, IDRT, task register, and a LDTR register.

Alternative examples may use wider or narrower registers. Additionally, alternative examples may use more, less, or different register files and registers. The register architecture 1600 may, for example, be used in physical register file(s) circuitry 1458.

Techniques and architectures for providing secure communications with a processor are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

In one or more first embodiments, an integrated circuit (IC) comprises a detector to receive an indication of a timeout of a completion message via an integrity and data encryption (IDE) protected channel in a trusted execution environment (TEE), wherein the IDE protected channel is to extend to each of an input/output (IO) device and one of a processor core or another IO device, an evaluation unit coupled to the detector, wherein, based on the indication, the evaluation unit is to identify a tag which corresponds to the timeout, and a prevented tag list coupled to the evaluation unit, wherein the evaluation unit is further to add the tag to the prevented tag list to prevent an availability of the tag with respect to communication via the IDE protected channel.

In one or more second embodiments, further to the first embodiment, the IO device and the one of the processor core or the other IO device are to be coupled to each other via a root complex which comprises the IC.

In one or more third embodiments, further to the first embodiment or the second embodiment, the IO device comprises the IC.

In one or more fourth embodiments, further to any of the first through third embodiments, the circuitry further comprises a classification unit coupled to the detector, wherein, based on the indication, the classification unit is to classify the IDE protected channel as being in an insecure state.

In one or more fifth embodiments, further to the fourth embodiment, the classification unit to classify the IDE protected channel as being in the insecure state comprises the classification unit to classify the IDE protected channel based on an overflow of the prevented tag list.

In one or more sixth embodiments, further to any of the first through fourth embodiments, the indication of the timeout is a first indication, the detector is further to receive a second indication that the timeout is benign, and based on the second indication, the evaluation unit is to remove the tag from the prevented tag list.

In one or more seventh embodiments, further to the sixth embodiment, the circuitry further comprises a classification unit coupled to the detector, wherein, based on the second indication, the classification unit is to classify the IDE protected channel as being in a secure state.

In one or more eighth embodiments, further to any of the first through fourth embodiments, the IDE protected channel is a first IDE protected channel, the prevented tag list is a first prevented tag list which is dedicated to the first IDE protected channel, and the IC further comprises a second prevented tag list which is dedicated to a second IDE protected channel.

In one or more ninth embodiments, further to any of the first through fourth embodiments, the prevented tag list is a first prevented tag list which is dedicated to a first IO requestor, and the IC further comprises a second prevented tag list which is dedicated to a second IO requestor.

In one or more tenth embodiments, a system comprises a processor core, an input/output (IO) device, and a root complex coupled between the processor core and the IO device, wherein one of the IO device or the root complex comprises an integrated circuit (IC) comprising a detector to receive an indication of a timeout of a completion message via an integrity and data encryption (IDE) protected channel in a trusted execution environment (TEE), wherein the IDE protected channel is to extend to each of the IO device and one of the processor core or another IO device, an evaluation unit coupled to the detector, wherein, based on the indication, the evaluation unit is to identify a tag which corresponds to the timeout, and a prevented tag list coupled to the evaluation unit, wherein the evaluation unit is further to add the tag to the prevented tag list to prevent an availability of the tag with respect to communication via the IDE protected channel.

In one or more eleventh embodiments, further to the tenth embodiment, the root complex comprises the IC.

In one or more twelfth embodiments, further to the tenth embodiment or the eleventh embodiment, the IO device comprises the IC.

In one or more thirteenth embodiments, further to any of the tenth through twelfth embodiments, the circuitry further comprises a classification unit coupled to the detector, wherein, based on the indication, the classification unit is to classify the IDE protected channel as being in an insecure state.

In one or more fourteenth embodiments, further to the thirteenth embodiment, the classification unit to classify the IDE protected channel as being in the insecure state comprises the classification unit to classify the IDE protected channel based on an overflow of the prevented tag list.

In one or more fifteenth embodiments, further to any of the tenth through thirteenth embodiments, the indication of the timeout is a first indication, the detector is further to receive a second indication that the timeout is benign, and based on the second indication, the evaluation unit is to remove the tag from the prevented tag list.

In one or more sixteenth embodiments, further to the fifteenth embodiment, the circuitry further comprises a classification unit coupled to the detector, wherein, based on the second indication, the classification unit is to classify the IDE protected channel as being in a secure state.

In one or more seventeenth embodiments, further to any of the tenth through thirteenth embodiments, the IDE protected channel is a first IDE protected channel, the prevented tag list is a first prevented tag list which is dedicated to the first IDE protected channel, and the IC further comprises a second prevented tag list which is dedicated to a second IDE protected channel.

In one or more eighteenth embodiments, further to any of the tenth through thirteenth embodiments, the prevented tag list is a first prevented tag list which is dedicated to a first IO requestor, and the IC further comprises a second prevented tag list which is dedicated to a second IO requestor.

In one or more nineteenth embodiments, a method at an integrated circuit (IC), the method comprises receiving an indication of a timeout of a completion message via an integrity and data encryption (IDE) protected channel in a trusted execution environment (TEE), wherein the IDE protected channel extends to each of an input/output (IO) device and one of a processor core or another IO device, based on the indication, identifying a tag which corresponds to the timeout, and adding the tag to the prevented tag list to prevent an availability of the tag with respect to communication via the IDE protected channel.

In one or more twentieth embodiments, further to the nineteenth embodiment, the IO device and the one of the processor core or the other IO device are coupled to each other via a root complex which comprises the prevented tag list.

In one or more twenty-first embodiments, further to the nineteenth embodiment or the twentieth embodiment, the IO device comprises the prevented tag list.

In one or more twenty-second embodiments, further to any of the nineteenth through twenty-first embodiments, the method further comprises based on the indication, classifying the IDE protected channel as being in an insecure state.

In one or more twenty-third embodiments, further to the twenty-second embodiment, classifying the IDE protected channel as being in the insecure state comprises classifying the IDE protected channel based on an overflow of the prevented tag list.

In one or more twenty-fourth embodiments, further to any of the nineteenth through twenty-second embodiments, the indication of the timeout is a first indication, the method further comprises receiving a second indication that the timeout is benign, and based on the second indication, removing the tag from the prevented tag list.

In one or more twenty-fifth embodiments, further to the twenty-fourth embodiment, the method further comprises based on the second indication, classifying the IDE protected channel as being in a secure state.

In one or more twenty-sixth embodiments, further to any of the nineteenth through twenty-second embodiments, the IDE protected channel is a first IDE protected channel, the prevented tag list is a first prevented tag list which is dedicated to the first IDE protected channel, and a second prevented tag list which is dedicated to a second IDE protected channel.

In one or more twenty-seventh embodiments, further to any of the nineteenth through twenty-second embodiments, the prevented tag list is a first prevented tag list which is dedicated to a first IO requestor, and a second prevented tag list which is dedicated to a second IO requestor.

In one or more twenty-eighth embodiments, one or more non-transitory computer-readable storage media have stored thereon instructions which, when executed by one or more processing units, cause the one or more processing units to perform a method comprising receiving an indication of a timeout of a completion message via an integrity and data encryption (IDE) protected channel in a trusted execution environment (TEE), wherein the IDE protected channel extends to each of an input/output (IO) device and one of a processor core or another IO device, based on the indication, identifying a tag which corresponds to the timeout, and adding the tag to the prevented tag list to prevent an availability of the tag with respect to communication via the IDE protected channel.

In one or more twenty-ninth embodiments, further to the twenty-eighth embodiment, the IO device and the one of the processor core or the other IO device are coupled to each other via a root complex which comprises the prevented tag list.

In one or more thirtieth embodiments, further to the twenty-eighth embodiment or the twenty-ninth embodiment, the IO device comprises the prevented tag list.

In one or more thirty-first embodiments, further to any of the twenty-eighth through thirtieth the method further comprises based on the indication, classifying the IDE protected channel as being in an insecure state.

In one or more thirty-second embodiments, further to the thirty-first embodiment, classifying the IDE protected channel as being in the insecure state comprises classifying the IDE protected channel based on an overflow of the prevented tag list.

In one or more thirty-third embodiments, further to any of the twenty-eighth through thirty-first embodiments, the indication of the timeout is a first indication, the method further comprises receiving a second indication that the timeout is benign, and based on the second indication, removing the tag from the prevented tag list.

In one or more thirty-fourth embodiments, further to the thirty-third embodiment, the method further comprises based on the second indication, classifying the IDE protected channel as being in a secure state.

In one or more thirty-fifth embodiments, further to any of the twenty-eighth through thirty-first embodiments, the IDE protected channel is a first IDE protected channel, the prevented tag list is a first prevented tag list which is dedicated to the first IDE protected channel, and a second prevented tag list which is dedicated to a second IDE protected channel.

In one or more thirty-sixth embodiments, further to any of the twenty-eighth through thirty-first embodiments, the prevented tag list is a first prevented tag list which is dedicated to a first IO requestor, and a second prevented tag list which is dedicated to a second IO requestor.

In one or more thirty-seventh embodiments, an integrated circuit (IC) comprises first circuitry to participate in communications while the IC is coupled to a root complex, the communications via an integrity and data encryption (IDE) protected channel in a trusted execution environment (TEE), with one of a TEE security manager (TSM) or a device security manager (DSM), wherein the IDE protected channel is to extend to each of an input/output (IO) device and one of a processor core or another IO device, and second circuitry coupled to the first circuitry, the second circuitry to send a request to flush the IDE protected channel, and receive, in response to the request, a message from the one of the TSM or the DSM, wherein the message is to indicate that a flush of the IDE protected channel has completed.

In one or more thirty-eighth embodiments, further to the thirty-seventh embodiment, the processor core comprises the first circuitry and the second circuitry, the IDE protected channel is to extend to each of the IO device and the processor core, and a root complex is to be coupled between the IO device and the processor core.

In one or more thirty-ninth embodiments, further to the thirty-eighth embodiment, the second circuitry to send the request to flush the IDE protected channel comprises the second circuitry to write to a flush request register of the root complex.

In one or more fortieth embodiments, further to the thirty-ninth embodiment, the root complex comprises multiple flush request registers which are each to correspond to a different respective one of multiple IDE protected channels.

In one or more forty-first embodiments, further to the thirty-seventh embodiment or the thirty-eighth embodiment, the IO device comprises the first circuitry and the second circuitry, the IDE protected channel is to extend to each of the IO device and the other IO device, and the IDE protected channel comprises a direct peer-to-peer (P2P) channel.

In one or more forty-second embodiments, further to the forty-first embodiment, the request to flush the IDE protected channel is a first request, and the second circuitry is to send the first request based on a second request, from the TSM, to stop a trusted device interface.

In one or more forty-third embodiments, further to the forty-first embodiment, the request to flush the IDE protected channel is a first request, and the second circuitry is to send the first request based on a second request, from the TSM, to unbind a trusted device interface.

In one or more forty-fourth embodiments, further to the thirty-seventh embodiment or the thirty-eighth embodiment, the second circuitry is to determine, based on a state of a trusted device interface (TDI), a number of flush operations to be performed.

In one or more forty-fifth embodiments, further to the forty-fourth embodiment, the second circuitry is to request only one flush operation based on a determination that the TDI is in an error state.

In one or more forty-sixth embodiments, further to the forty-fourth embodiment, the second circuitry is to request multiple flush operations based on a determination that the TDI is in a run state.

In one or more forty-seventh embodiments, one or more non-transitory computer-readable storage media have stored thereon instructions which, when executed by one or more processing units, cause the one or more processing units to perform a method comprising participating in communications while the one or more processing units are coupled to a root complex, the communications via an integrity and data encryption (IDE) protected channel in a trusted execution environment (TEE), with one of a TEE security manager (TSM) or a device security manager (DSM), wherein the IDE protected channel extends to each of an input/output (IO) device and one of a processor core or another IO device, sending a request to flush the IDE protected channel, and receiving, in response to the request, a message from the one of the TSM or the DSM, wherein the message indicates that a flush of the IDE protected channel has completed.

In one or more forty-eighth embodiments, further to the forty-seventh embodiment, the request is sent from the processor core, the IDE protected channel extends to each of the IO device and the processor core, and a root complex is coupled between the IO device and the processor core.

In one or more forty-ninth embodiments, further to the forty-eighth embodiment, sending the request to flush the IDE protected channel comprises writing to a flush request register of the root complex.

In one or more fiftieth embodiments, further to the forty-ninth embodiment, the root complex comprises multiple flush request registers which each correspond to a different respective one of multiple IDE protected channels.

In one or more fifty-first embodiments, further to the forty-seventh embodiment or the forty-eighth embodiment, the request is sent from the IO device, the IDE protected channel extends to each of the IO device and the other IO device, and the IDE protected channel comprises a direct peer-to-peer (P2P) channel.

In one or more fifty-second embodiments, further to the fifty-first embodiment, the request to flush the IDE protected channel is a first request, and the first request is sent based on a second request, from the TSM, to stop a trusted device interface.

In one or more fifty-third embodiments, further to the fifty-first embodiment, the request to flush the IDE protected channel is a first request, and the first request is sent based on a second request, from the TSM, to unbind a trusted device interface.

In one or more fifty-fourth embodiments, further to the forty-seventh embodiment or the forty-eighth embodiment, the method further comprises determining, based on a state of a trusted device interface (TDI), a number of flush operations to be performed.

In one or more fifty-fifth embodiments, further to the fifty-fourth embodiment, only one flush operation is requested based on a determination that the TDI is in an error state.

In one or more fifty-sixth embodiments, further to the fifty-fourth embodiment, multiple flush operations are requested based on a determination that the TDI is in a run state.

In one or more fifty-seventh embodiments, a system comprises a processor core, an input/output (IO) device, and a root complex coupled between the processor core and the IO device, wherein one of the IO device or the processor core comprises an integrated circuit (IC) comprising first circuitry to participate in communications, via an integrity and data encryption (IDE) protected channel in a trusted execution environment (TEE), with one of a TEE security manager (TSM) or a device security manager (DSM), wherein the IDE protected channel is to extend to each of the IO device and one of the processor core or another IO device, and second circuitry coupled to the first circuitry, the second circuitry to send a request to flush the IDE protected channel, and receive, in response to the request, a message from the one of the TSM or the DSM, wherein the message is to indicate that a flush of the IDE protected channel has completed.

In one or more fifty-eighth embodiments, further to the fifty-seventh embodiment, the processor core comprises the first circuitry and the second circuitry, the IDE protected channel is to extend to each of the IO device and the processor core, and a root complex is to be coupled between the IO device and the processor core.

In one or more fifty-ninth embodiments, further to the fifty-eighth embodiment, the second circuitry to send the request to flush the IDE protected channel comprises the second circuitry to write to a flush request register of the root complex.

In one or more sixtieth embodiments, further to the fifty-ninth embodiment, the root complex comprises multiple flush request registers which are each to correspond to a different respective one of multiple IDE protected channels.

In one or more sixty-first embodiments, further to the fifty-seventh embodiment or the fifty-eighth embodiment, the IO device comprises the first circuitry and the second circuitry, the IDE protected channel is to extend to each of the IO device and the other IO device, and the IDE protected channel comprises a direct peer-to-peer (P2P) channel.

In one or more sixty-second embodiments, further to the sixty-first embodiment, the request to flush the IDE protected channel is a first request, and the second circuitry is to send the first request based on a second request, from the TSM, to stop a trusted device interface.

In one or more sixty-third embodiments, further to the sixty-first embodiment, the request to flush the IDE protected channel is a first request, and the second circuitry is to send the first request based on a second request, from the TSM, to unbind a trusted device interface.

In one or more sixty-fourth embodiments, further to the fifty-seventh embodiment or the fifty-eighth embodiment, the second circuitry is to determine, based on a state of a trusted device interface (TDI), a number of flush operations to be performed.

In one or more sixty-fifth embodiments, further to the sixty-fourth embodiment, the second circuitry is to request only one flush operation based on a determination that the TDI is in an error state.

In one or more sixty-sixth embodiments, further to the sixty-fourth embodiment, the second circuitry is to request multiple flush operations based on a determination that the TDI is in a run state.

In one or more sixty-seventh embodiments, a method comprises participating in communications, via a root complex and an integrity and data encryption (IDE) protected channel in a trusted execution environment (TEE), with one of a TEE security manager (TSM) or a device security manager (DSM), wherein the IDE protected channel extends to each of an input/output (IO) device and one of a processor core or another IO device, sending a request to flush the IDE protected channel, and receiving, in response to the request, a message from the one of the TSM or the DSM, wherein the message indicates that a flush of the IDE protected channel has completed.

In one or more sixty-eighth embodiments, further to the sixty-seventh embodiment, the request is sent from the processor core, the IDE protected channel extends to each of the IO device and the processor core, and a root complex is coupled between the IO device and the processor core.

In one or more sixty-ninth embodiments, further to the sixty-eighth embodiment, sending the request to flush the IDE protected channel comprises writing to a flush request register of the root complex.

In one or more seventieth embodiments, further to the sixty-ninth embodiment, the root complex comprises multiple flush request registers which each correspond to a different respective one of multiple IDE protected channels.

In one or more seventy-first embodiments, further to the sixty-seventh embodiment or the sixty-eighth embodiment, the request is sent from the IO device, the IDE protected channel extends to each of the IO device and the other IO device, and the IDE protected channel comprises a direct peer-to-peer (P2P) channel.

In one or more seventy-second embodiments, further to the seventy-first embodiment, the request to flush the IDE protected channel is a first request, and the first request is sent based on a second request, from the TSM, to stop a trusted device interface.

In one or more seventy-third embodiments, further to the seventy-first embodiment, the request to flush the IDE protected channel is a first request, and the first request is sent based on a second request, from the TSM, to unbind a trusted device interface.

In one or more seventy-fourth embodiments, further to the sixty-seventh embodiment or the sixty-eighth embodiment, the method further comprises determining, based on a state of a trusted device interface (TDI), a number of flush operations to be performed.

In one or more seventy-fifth embodiments, further to the seventy-fourth embodiment, only one flush operation is requested based on a determination that the TDI is in an error state.

In one or more seventy-sixth embodiments, further to the seventy-fourth embodiment, multiple flush operations are requested based on a determination that the TDI is in a run state.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. An integrated circuit (IC) comprising:
a detector to receive an indication of a timeout of a completion message via an integrity and data encryption (IDE) protected channel in a trusted execution environment (TEE), wherein the IDE protected channel is to extend to each of an input/output (IO) device and one of a processor core or another IO device;
an evaluation unit coupled to the detector, wherein, based on the indication, the evaluation unit is to identify a tag which corresponds to the timeout; and
a prevented tag list coupled to the evaluation unit, wherein the evaluation unit is further to add the tag to the prevented tag list to prevent an availability of the tag with respect to communication via the IDE protected channel.

2. The IC of claim 1, wherein the IO device and the one of the processor core or the other IO device are to be coupled to each other via a root complex which comprises the IC.

3. The IC of claim 1, wherein the IO device comprises the IC.

4. The IC of claim 1, the circuitry further comprising a classification unit coupled to the detector, wherein, based on the indication, the classification unit is to classify the IDE protected channel as being in an insecure state.

5. The IC of claim 4, wherein the classification unit to classify the IDE protected channel as being in the insecure state comprises the classification unit to classify the IDE protected channel based on an overflow of the prevented tag list.

6. The IC of claim 1, wherein:
the indication of the timeout is a first indication;
the detector is further to receive a second indication that the timeout is benign; and
based on the second indication, the evaluation unit is to remove the tag from the prevented tag list.

7. The IC of claim 6, the circuitry further comprising a classification unit coupled to the detector, wherein, based on the second indication, the classification unit is to classify the IDE protected channel as being in a secure state.

8. The IC of claim 1, wherein:
the IDE protected channel is a first IDE protected channel;
the prevented tag list is a first prevented tag list which is dedicated to the first IDE protected channel; and
the IC further comprises a second prevented tag list which is dedicated to a second IDE protected channel.

9. The IC of claim 1, wherein:
the prevented tag list is a first prevented tag list which is dedicated to a first IO requestor; and
the IC further comprises a second prevented tag list which is dedicated to a second IO requestor.

10. A system comprising:
a processor core;
an input/output (IO) device; and
a root complex coupled between the processor core and the IO device;
wherein one of the IO device or the root complex comprises an integrated circuit (IC) comprising:
a detector to receive an indication of a timeout of a completion message via an integrity and data encryption (IDE) protected channel in a trusted execution environment (TEE), wherein the IDE protected channel is to extend to each of the IO device and one of the processor core or another IO device;
an evaluation unit coupled to the detector, wherein, based on the indication, the evaluation unit is to identify a tag which corresponds to the timeout; and
a prevented tag list coupled to the evaluation unit, wherein the evaluation unit is further to add the tag to the prevented tag list to prevent an availability of the tag with respect to communication via the IDE protected channel.

11. The system of claim 10, wherein the root complex comprises the IC.

12. The system of claim 10, wherein the IO device comprises the IC.

13. The system of claim 10, the circuitry further comprising a classification unit coupled to the detector, wherein, based on the indication, the classification unit is to classify the IDE protected channel as being in an insecure state.

14. The system of claim 10, wherein:
the indication of the timeout is a first indication;
the detector is further to receive a second indication that the timeout is benign; and
based on the second indication, the evaluation unit is to remove the tag from the prevented tag list.

15. An integrated circuit (IC) comprising:
first circuitry to participate in communications while the IC is coupled to a root complex, the communications via an integrity and data encryption (IDE) protected channel in a trusted execution environment (TEE), with one of a TEE security manager (TSM) or a device security manager (DSM), wherein the IDE protected channel is to extend to each of an input/output (IO) device and one of a processor core or another IO device; and
second circuitry coupled to the first circuitry, the second circuitry to:
send a request to flush the IDE protected channel; and
receive, in response to the request, a message from the one of the TSM or the DSM, wherein the message is to indicate that a flush of the IDE protected channel has completed.

16. The IC of claim 15, wherein:
the processor core comprises the first circuitry and the second circuitry;
the IDE protected channel is to extend to each of the IO device and the processor core; and
a root complex is to be coupled between the IO device and the processor core.

17. The IC of claim 15, wherein:
the IO device comprises the first circuitry and the second circuitry;
the IDE protected channel is to extend to each of the IO device and the other IO device; and
the IDE protected channel comprises a direct peer-to-peer (P2P) channel.

18. The IC of claim 17, wherein:
the request to flush the IDE protected channel is a first request; and
the second circuitry is to send the first request based on a second request, from the TSM, to stop a trusted device interface.

19. The IC of claim 17, wherein:
the request to flush the IDE protected channel is a first request; and
the second circuitry is to send the first request based on a second request, from the TSM, to unbind a trusted device interface.

20. The IC of claim 15, wherein the second circuitry is to determine, based on a state of a trusted device interface (TDI), a number of flush operations to be performed.
